(19) United States
(12) Patent Application Publication
(10) Pub. No.: US 2014/0189203 A1
(43) Pub. Date: Jul. 3, 2014

(54) STORAGE APPARATUS AND STORAGE CONTROL METHOD

(71) Applicant: Hitachi, Ltd., Tokyo (JP)

(72) Inventors: Akifumi Suzuki, Yokohama (JP); Junji Ogawa, Sagamihara (JP); Akira Yamamoto, Sagamihara (JP)

(73) Assignee: Hitachi, Ltd., Tokyo (JP)

(21) Appl. No.: 13/811,008

(22) PCT Filed: Dec. 28, 2012
(86) PCT No.: PCT/JP12/08437

§ 371 Date: Jan. 18, 2013

(51) Int. Cl. G06F 12/02

(52) U.S. Cl. CPC G06F 12/0246
USPC 711/103

(57) ABSTRACT

A cache memory (CM) in which data, which is accessed with respect to a storage device, is temporarily stored is coupled to a controller for accessing the storage device in accordance with an access command from a higher-level apparatus. The CM comprises a nonvolatile semi-conductor memory (NVM), and provides a logical space to the controller. The controller is configured to partition the logical space into multiple segments and to manage these segments, and to access the CM by specifying a logical address of the logical space. The CM receives the logical address-specified access, and accesses a physical area allocated to a logical area, which belongs to the specified logical address. A first management unit, which is a unit of a segment, is larger than a second management unit, which is a unit of an access performed with respect to the NVM. The capacity of the logical space is larger than the storage capacity of the NVM.

### TECHNICAL FIELD

The present invention relates to storage control using a nonvolatile semiconductor memory as a cache.

### BACKGROUND ART

A storage apparatus, for example, is an apparatus for controlling multiple storage devices (for example, HDD (Hard Disk Drives)) and storing large amounts of data in these storage devices in a highly reliable manner. A storage apparatus such as this performs simultaneous processing of multiple HDDs, and processes an access (either a read or a write) command from a server or other such higher-level apparatus.

The storage apparatus manages multiple storage areas (for example, LU (Logical Units)), which are based on the multiple storage devices. It is generally known that an area accessed frequently from among all storage areas managed by the storage apparatus is the principle of locality. Thus, it is widely known that the processing performance of access commands performed with respect to all the storage areas is improved on average in accordance with the storage apparatus rapidly processing access commands to the frequently accessed area.

The storage apparatus comprises a component called a cache for the high-performance processing of the frequently accessed area with the objective of enhancing the processing performance (hereinafter, described simply as performance) with respect to access commands in general. The cache, for example, is an area for storing data, which is in a relatively high-access storage area of the storage areas managed by the storage apparatus, and is generally a DRAM (Dynamic Random Access Memory). The DRAM processes an access command faster than an HDD, and when data pertaining to the locality principle is stored on the DRAM in a case where there is locality in the access frequency of access commands, performance with respect to storage apparatus access commands improves since the majority of all access commands can be processed on the DRAM (because accesses to the slower processing HDD group can be reduced).

Meanwhile, in accordance with the downscaling of semiconductor manufacturing processes and the realization of multilevel memories in recent years, the cost-per-bit of nonvolatile semiconductor memory (hereinafter NVM), such as NAND-type flash memory (hereinafter FM), has dropped, and NVM is being put to use in a wide range of applications.

As one example of this, a cache apparatus, which causes a FM to perform processing as a storage apparatus cache, has been disclosed (for example, Patent Literature 1). There is also software for controlling a SSD (Solid State Drive), which is a storage device that makes use of FM, as a cache.

The cost-per-bit of FM has dropped in recent years, making it possible to increase the capacity of the cache at low cost. When the cache capacity is increased, the probability for enabling an access command from a higher-level apparatus to be processed on the cache increases, and as such, is effective at speeding up processing performance for a storage apparatus access command.

### CITATION LIST

### Patent Literature

PTL 1: US Patent Application Publication No. 2009/0216945

### SUMMARY OF INVENTION

### Technical Problem

Hereinbelow, a case where data, which conforms to an access command from a higher-level apparatus, exists on the cache will be described as a “cache hit”. In addition, a case where data, which conforms to an access command from a higher-level apparatus does not exist on the cache, will be described as a “cache miss”. Also, hereinbelow the read/write unit of a NVM will be described as a page and the NVM erase unit will be described as a block. The unit of management for a cache area managed by the storage apparatus will be called a segment.

The storage apparatus manages data to be stored in the cache and a range of addresses for the data so that an access command from a higher-level apparatus has a high probability of being processed on the cache. LRU (Least Recently Used), which is one such cache management method, is known as a method for eliminating from the cache “a data address range with the longest elapsed time period subsequent to a request”. According to this LRU, data and a data address range, which are accessed frequently, are apt to remain on the cache, and have a higher probability of becoming a cache hit. Alternatively, data and a data address range, which are accessed in-frequently, are apt to be eliminated from the cache. However, this kind of cache management may put a load on the storage apparatus processor.

The processor load changes in accordance with the size of a segment, which is an access range unit. For example, when the size of the segment is 16 KB, in order to process a command having an access range of 128 KB, the processor must control 128/16=8 segments. Alternatively, in a case where the segment size is 128 KB, the processor need only control one segment in order to process a command having a 128-KB access range.

Thus, in order to lessen the load on the processor, the number of segments to be processed may be reduced. That is, it is desirable that the size of the segment be the largest size within a size, which is smaller than the maximum access command size (for example, 128 KB).

However, when the segment size is enlarged, a problem arises in that the utilization efficiency of the storage area decreases. For example, when the segment size is 128 KB, one 128-KB segment supports the processing of a command having an access range of 8 KB, and as such, 128-8=120 KB of the segment is not used. In the case of a 16-KB segment size, an area of 16-8=8 KB of the segment is not used. That is, when the segment size is large, there is the likelihood of the unused area becoming large.

Thus, in order to make efficient use of the cache, it is desirable that the size of the segment be equal to or larger than the smallest write unit of a storage medium, and, in addition, be small in size.

As described hereinabove, there is a tradeoff between the desirability for the size of the segment, which is the cache management unit, to be large from the standpoint of reducing the load on the processor, and the desirability for the size to be small from the standpoint of enhancing the utilization efficiency of the storage area.

### Solution to Problem

In a storage apparatus, a cache memory (CM) in which data, which is accessed with respect to a storage device, is temporarily stored is coupled to a controller for accessing the storage device in accordance with an access command from a higher-level apparatus. The CM comprises a nonvolatile semiconductor memory (NVM), and provides a logical space to the controller. The controller is configured to partition the logical space into multiple segments and to manage these segments, and to access the CM by specifying a logical address of the logical space. The CM receives the logical address-specified access, and accesses a physical area allocated to the logical area, which belongs to the specified logical address. A first management unit, which is a unit of a segment, is larger than a second management unit, which is a unit of an access performed with respect to the NVM. The capacity of the logical space is larger than the storage capacity of the NVM.

### Advantageous Effects of Invention

Although the CM segment (the first management unit) is larger than the NVM management unit (the second management unit) of the CM, this difference in area (difference in management units) is absorbed in accordance with a CM logical-physical translation function, and, in addition, since the capacity of the logical space is larger than the capacity of the NVM, the utilization efficiency of the NVM can be enhanced.

### BRIEF DESCRIPTION OF DRAWINGS

FIG. 1 is a schematic block diagram of a computer system related to a first example.

FIG. 2 is an internal block diagram of an NVM module 126 related to the first example.

FIG. 3 is a schematic block diagram of an FM chip 220 related to the first example.

FIG. 4 is a schematic block diagram of an FM chip block 302 related to the first example.

FIG. 5 is an internal block diagram of an FM chip page 401 related to the first example.

FIG. 6 shows cache hit determination information 600 related to the first example.

FIG. 7 shows cache segment management information 700 related to the first example.

FIG. 8 shows cache attribute number management information 800 related to the first example.

FIG. 9 shows an LBA-PBA translation table 900 related to the first example.

FIG. 10 shows block management information 1000 related to the first example.

FIG. 11 shows PBA allocation management information 1100 related to the first example.

FIG. 12 is a conceptual drawing depicting transitions of segment attributes in a cache control related to the first example.

FIG. 13 shows an example of a write process in a storage controller 110 related to the first example.

FIG. 14 shows an example of a segment release process in the storage controller 110 related to the first example.

FIG. 15 shows an example of a write process in a NVM module 126 related to the first example.

FIG. 16 shows an example of a read process in the storage controller 110 related to the first example.

FIG. 17 shows an example of a cache hit read process in the storage controller 110 related to the first example.

FIG. 18 shows an example of a cache miss read process in the storage controller 110 related to the first example.

FIG. 19 shows an example of a read process in the NVM module 126 related to the first example.

FIG. 20 shows an overview of a LBA-PBA association in the first example.

FIG. 21 shows a LBA-PBA translation table 2100 of a second example.

FIG. 22 shows an example of a write process in a NVM module 126 related to the second example.

FIG. 23 shows an example of a read process in the NVM module 126 related to the second example.

FIG. 24 is a conceptual drawing showing an outline of a reclamation process related to a third example.

FIG. 25 shows block management information 2500 related to the third example.

FIG. 26 shows PBA allocation management information 2600 related to the third example.

FIG. 27 is a conceptual drawing depicting transitions of segment attributes in a cache control related to the third example.

FIG. 28 shows an example of a spare area augmentation process performed by an NVM module 126 related to a fourth example.

### DESCRIPTION OF THE EMBODIMENT

A number of examples will be explained based on the drawings. Furthermore, the present invention is not limited to the examples explained below. An example is given in which a NAND-type flash memory (hereinafter, FM) is explained as a nonvolatile semiconductor memory (NVM), but the nonvolatile semiconductor memory of the present invention is not limited to an FM.

In the following explanation, the configuration is such that a NVM module is included in the storage apparatus, but the configuration can also be such that the NVM module is not included in the storage apparatus.

Also, in the following explanation, the storage apparatus comprises multiple storage devices, but at least one of the multiple storage devices may exist outside of the storage apparatus.

### Example 1

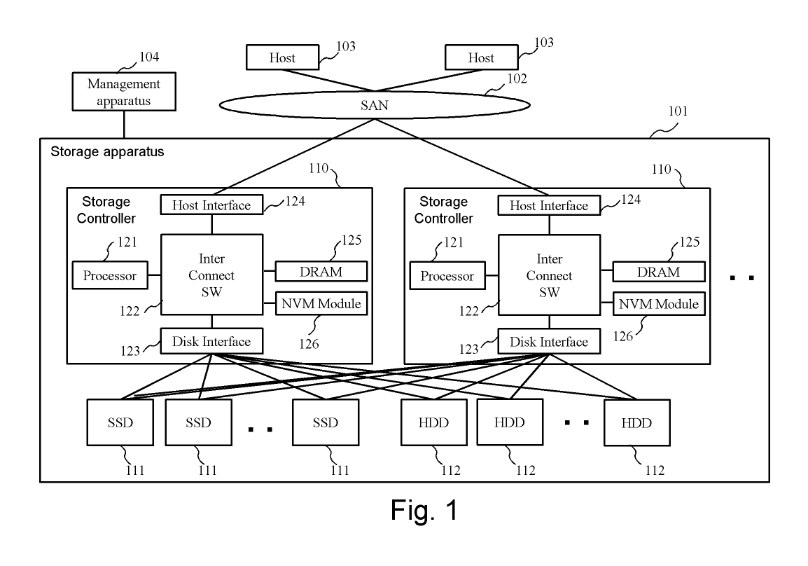

FIG. 1 is a schematic block diagram of a computer system related to a first example.

The computer system comprises a storage apparatus 101 comprising a nonvolatile semiconductor memory module (hereinafter NVM (Non-volatile memory) module) 126. The NVM module 126, for example, comprises a FM (Flash Memory) as a storage medium. The NVM module 126 may exist outside the storage apparatus 101.

The storage apparatus 101 comprises multiple storage controllers 110. Each storage controller 110 comprises a disk interface 123, which is coupled to a storage device (for example, a SSD (Solid State Drive) 111 or a HDD (Hard Disk Drive) 112) and a host interface 124, which is coupled to a higher-level apparatus (for example, a host 103).

The host interface 124, for example, is a device, which supports a protocol, such as FC (Fibre Channel), iSCSI (internet Small Computer System Interface), or FCoE (Fibre Channel over Ether).

The disk interface 123, for example, is a device, which supports various protocols, such as FC, SAS (Serial Attached SCSI), SATA (Serial Advanced Technology Attachment), and PCI (Peripheral Component Interconnect)-Express.

The storage controller 110 comprises a processor 121, a DRAM (Dynamic Random Access Memory) 125, and other such hardware resources, and under the control of the processor 121, performs read/write command processing from/to a storage device, such as the SSD 111 or the HDD 112, in accordance with a read/write command from the higher-level apparatus 103. The NVM module 126 is coupled to the storage controller 110. The NVM module 126 can be controlled from the processor 121 via an internal switch 122.

The storage controller 110 also comprises a RAID (Redundant Arrays of Inexpensive (or Independent) Disks) parity creation function, and a RAID parity-based data restoration function. The storage controller 110 manages either multiple SSDs 111 or multiple HDDs 112 as a RAIDgroup using an arbitrary unit. Also, the storage controller 110 partitions the RAID group into LUs (Logical Unit) and provides an LU to the higher-level apparatus 103 as a storage area using an arbitrary unit.

The storage controller 110, upon receiving a write command specifying a write destination (for example, a LUN (Logical Unit Number) and a LBA (Logical Block Address)) from the higher-level apparatus 103, for example, can create a parity related to data, which conforms to the write command, and can write the created parity to the storage device together with the data from the higher-level apparatus 103. The storage controller 110, upon receiving a read command specifying a read source (for example, a LUN and a LBA) from the higher-level apparatus 103, can, after reading the data from the storage device based on the read source, check whether or not there has been data loss, and in a case where data loss has been detected, can use the parity to restore the data for which the data loss was detected, and send the restored data to the higher-level apparatus 103.

Furthermore, the storage controller 110 possesses functions for monitoring and managing a storage device failure, utilization status, and processing status.

The storage apparatus 101 is communicably coupled to a management apparatus 104 via a communication network. The communication network, for example, can be a LAN (Local Area Network). The communication network has been omitted from FIG. 1 for the sake of simplification, but is coupled to each storage controller 110 inside the storage apparatus 101. The communication network may be a SAN 102.

The management apparatus 104, for example, is a computer comprising hardware resources, such as a processor, a memory, a network interface, and a local input/output device, and a software resource, such as a management program. The management apparatus 104 can use a program to acquire information from the storage apparatus 101, and can display the information on a management screen. A system administrator, for example, can use the management screen displayed on the management apparatus 104 to monitor and control the storage apparatus 101.

Multiple SSDs 111 (for example, 16) exist inside the storage apparatus 101. The SSD 111 is coupled to a storage controller 110, multiple of which exist inside the same storage apparatus 101, and to the disk controller 123.

The SSD 111 stores data, which is received together with a write command from the storage controller 110, fetches the stored data in accordance with a read command, and sends the fetched data to the storage controller 110. Furthermore, at this time, the disk interface 123 uses a logical address (for example, a LBA (Logical Block Address) to specify a logical storage location of the data related to the read/write command to the SSD 111. The storage controller 110 can partition and manage multiple SSDs 111 as multiple RAID configurations in accordance with a specification from the higher-level apparatus 103, and when there is data loss, can use a configuration that enables the lost data to be restored.

Multiple HDDs 112 (for example, 120) exist inside the storage apparatus 101, and like the SSDs 111, are coupled via the disk intrerface 123 to the multiple storage controllers 110 inside the same storage apparatus 101. The HDD 112, for example, stores data received together with a write command from the storage controller 110, fetches the stored data in accordance with a read request, and sends the fetched data to the storage controller 110.

At this time, the disk interface 123 uses a logical address (for example, a LBA) to specify to the HDD 112 the logical storage location of the data related to the read/write command. The storage controller 110 can partition and manage multiple HDDs 112 as multiple RAID configurations, and when there is data loss, can use a configuration that enables the lost data to be restored.

The storage controller 110 is coupled to the higher-level apparatus 103 via the host interface 124 and the SAN 102. Although omitted from FIG. 1 for the sake of simplification, the storage controllers 110 can be coupled via a coupling path. The coupling path, for example, can make it possible to communicate data and control information back and forth between the storage controllers 110.

The higher-level apparatus 103, for example, is equivalent to a computer, a file server or the like constituting the core of a business system. The higher-level apparatus 103 comprises hardware resources, such as a processor, a memory, a network interface, and a local input/output device, and comprises software resources, such as a device driver, an operating system (OS), and an application program. In accordance with this, the higher-level apparatus 103, under the control of the processor, is able to communicate with the storage apparatus 101 by executing various programs, and sends a data read/write command to the storage apparatus 101.

The higher-level apparatus 103, under the control of the processor, is also able to acquire management information, such as the utilization status of the storage apparatus 101 and the processing status of the storage apparatus 101, by executing various programs. The higher-level apparatus 103 is also able to specify via the storage apparatus 101 a setting for a storage device management unit, a setting for a storage device control method, and a setting related to data compression with respect to the storage device, and is also able to change the specified settings.

The preceding has been an explanation of the configuration of the computer system related to this example.

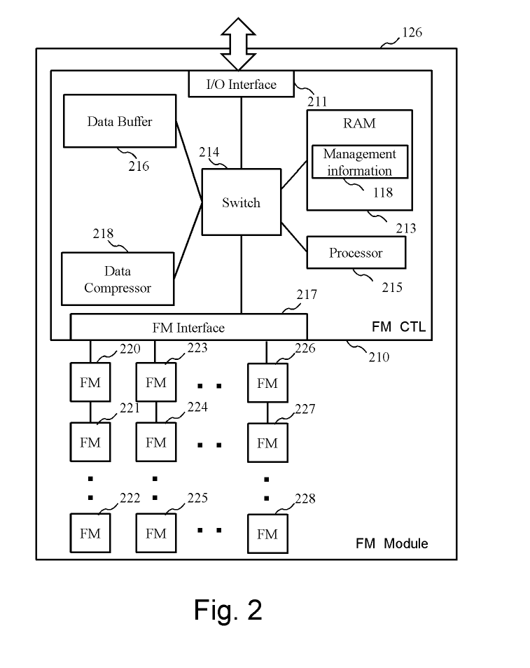

Next, FIG. 2 will be used to explain an internal configuration of the NVM module 126.

FIG. 2 is a drawing showing the internal configuration of the NVM module 126 related to the first example. The NVM module 126 internally comprises a flash memory (FM) controller 210, and multiple (for example, 32) flash memory chips (hereinafter, FM chips) 220 through 228.

The FM controller 210 internally comprises a processor 215, a RAM 213, a data compressor 218, a data buffer 216, an I/O interface 211, a FM (Flash Memory) interface 217, and a switch 214 for these internal components to send data to each other.

The switch 214 is mutually coupled to each component of the FM controller 210 (the processor 215, the RAM 213, the data compressor 218, the data buffer 216, the I/O interface 211, and the FM interface 217), and routes and sends data between the respective components using either an address or an ID.

The I/O interface 211 is coupled to the internal switch 122 of the storage controller 110 inside the storage apparatus 101, and mediates a communication between the NVM module 126 and the storage controller 110. The I/O interface 211 is also coupled to the respective components of the FM controller 210 via the switch 214.

The I/O interface 211 receives a logical address (for example, a LBA) specified by an access request (either a read request or a write request) from the storage controller 110. In a case where the access request is a write request, the I/0 interface 211 receives data, which conforms to the write request, from the storage controller 110, and stores the received data in the RAM 213 inside the FM controller 210.

The I/O interface 211 also receives an indication from the processor 121 of the storage controller 110, and issues an interrupt command to the processor 215 inside the FM controller 210. In addition, the I/O interface 211 receives a command for controlling the NVM module 126 from the storage controller 110, and notifies the storage controller 110 of the processing status, utilization status, and current setting values of the NVM module 126 in accordance with the command.

The processor 215 is coupled to the respective components of the FM controller 210 via the switch 214, and controls the entire FM controller 210 based on a program and management information stored in the RAM 213. The processor 215 monitors the entire FM controller 210 by regularly acquiring information and using an interrupt receiving function.

The data buffer 216 temporarily stores data in the FM controller 210 during a data send process.

The FM interface 217 is coupled to the respective FM chips (220 through 228) via multiple buses (for example, 16). Multiple (for example, two) FM chips (220 and so on) are coupled to each bus. The FM interface 217 uses a CE (Chip Enable) signal to independently control the multiple FM chips (220 through 228) coupled to the same bus.

The FM interface 217 performs processing in accordance with a read/write command from the processor 215. For example, the numbers of a chip, a block, and a page are specified in the read/write command. The FM interface 217, which has received the chip, the block, and the page numbers, processes the block- and page-specified read/write command with respect to the read/write command-target FM chips (220 through 228).

Specifically, for example, at read processing time, the FM interface 217 reads data from the FM chips (220 through 228) and sends the data to the data buffer 216, and at write processing time, reads the data (write-target data) from the data buffer 216, and writes the data to the FM chips (220 through 228).

The FM interface 217 comprises an ECC creation circuit, an ECC-based data loss detection circuit, and an ECC correction circuit.

The FM interface 217, at write processing time, uses the ECC creation circuit to create an ECC to be appended to the write data, and writes the created ECC together with the write data to the FM chips (220 through 228). At data read time, the FM interface 217 uses the ECC-based data loss detection circuit to check the data, which has been read from the FM chips (220 through 228), and upon detecting a data loss, uses the ECC correction circuit to correct the data, and stores the number of corrected Bits in the RAM 213 so as to notify the processor 215.

The data compressor 218 comprises a function for processing an algorithm, which reversibly compresses data, and comprises multiple types of algorithms and a function for changing the compression level. The data compressor 218 reads data from the data buffer 216 in accordance with an indication from the processor 215, uses the reversible compression algorithm to perform either a data compression operation or a data decompression operation, which reconverts the data compression, and writes the result thereof to the data buffer 216 once again. The data compressor 218 may be implemented as a logical circuit, or the same function may be realized in accordance with the processor processing a compression/decompression program.

In this example, the switch 214, the I/O interface 211, the processor 215, the data buffer 216, the FM interface 217, and the data compressor 218 may be configured inside a single semiconductor device as an ASIC (Application Specific Integrated Circuit) or a FPGA (Field Programmable Gate Array), or may be configured by mutually coupling multiple individual dedicated ICs (Integrated Circuits) to one another.

The RAM 213, specifically, is a DRAM or other such volatile memory. The RAM 213 stores management information for the FM chips (220 through 228) used inside the NVM module 126, and a send list comprising send control information used in each DMA (Direct Memory Access). The RAM 213 may be configured to comprise either all or part of the functions of the data buffer 216 for storing data.

The configuration of the NVM module 126 has been explained hereinabove using FIG. 2. In this example, the NVM is a flash memory (FM). It is supposed that the FM is a typical NAND-type FM, the type of flash memory in which an erase is performed in block units and an access is performed in page units. However, the FM may be another type of FM (for example, a NOR type) instead of a NAND type. Also, another type of NVM, for example, a phase-change memory, or a resistive random access memory, may be used instead of an FM. Furthermore, in this example, the data compressor 218 is not an essential component.

Next, the FM chip will be explained.

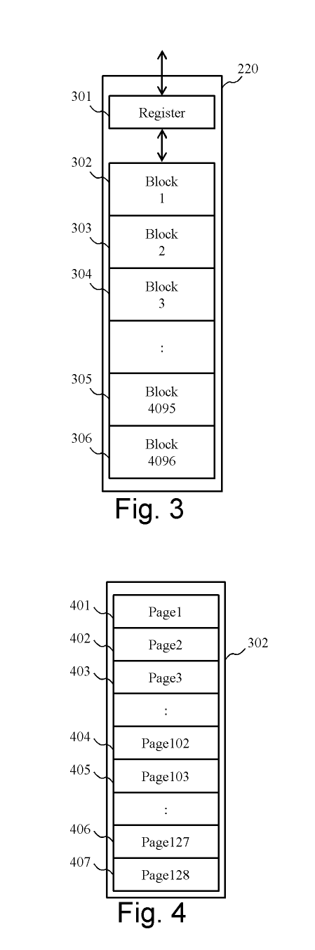

FIG. 3 is a schematic block diagram of a FM chip 220 related to the first example.

The FM chip 220 will be explained here, but the same configuration also applies to the other FM chips (221 through 228).

The FM chip 220 comprises a storage area configured from multiple (for example, 4096) physical blocks 302 through 306. In the FM chip 220, data can only be erased in block units. Multiple pages can be stored in each block. The FM chip 220 also comprises an I/O register 301. The I/O register 301 has a storage capacity of equal to or larger than the page size (for example, 4 KB+a spare area for appending an ECC).

The FM chip 220 performs processing in accordance with a read/write command from the FM interface 217.

At write processing time, first of all, the FM chip 220 receives a write command and a request-target block, a page number, and an in-page program start location from the FM interface 217. Next, the FM chip 220 stores the write data sent from the FM interface 217 in the I/O register 301 in order from the address corresponding to page program start location. Thereafter, the FM chip 220 receives an send end data command and writes the data stored in the I/O register 301 to the specified page.

At read processing time, first of all, the FM chip 220 receives a read command, and a request-target block and page number from the FM interface 217. Next, the FM chip 220 reads the data stored in the page of the specified block, and stores the data in the I/O register 301. Thereafter, the FM chip 220 sends the data stored in the I/O register 301 to the FM interface 217.

Next, an FM chip block will be explained.

FIG. 4 is a schematic block diagram of an FM chip block 302 related to the first example.

Block 302 will be explained here, but the same configuration also applies to the other blocks 303 through 306.

The block 302 is segmented into multiple (for example, 128) pages 401 through 407. In the block 302, a stored-data read and a data write can only be processed in page units. The order for writing to the pages 401 through 407 inside the block 302 is defined as being from the page at the top of the block, that is, page 401, 402, 403, . . ., in that order. Furthermore, writing over a written page in the block 302 is prohibited, and the relevant page cannot be written to again until the entire block to which the relevant page belongs has been erased.

Thus, the NVM module 126 related to this example manages a logical address (LBA) specified by the storage controller 110 and an address that specifies a physical storage area inside the NVM module 126 (a physical block address: PBA) as separate address systems, and manages information showing the association between the LBA and the PBA using a table.

Next, a page inside the block will be explained.

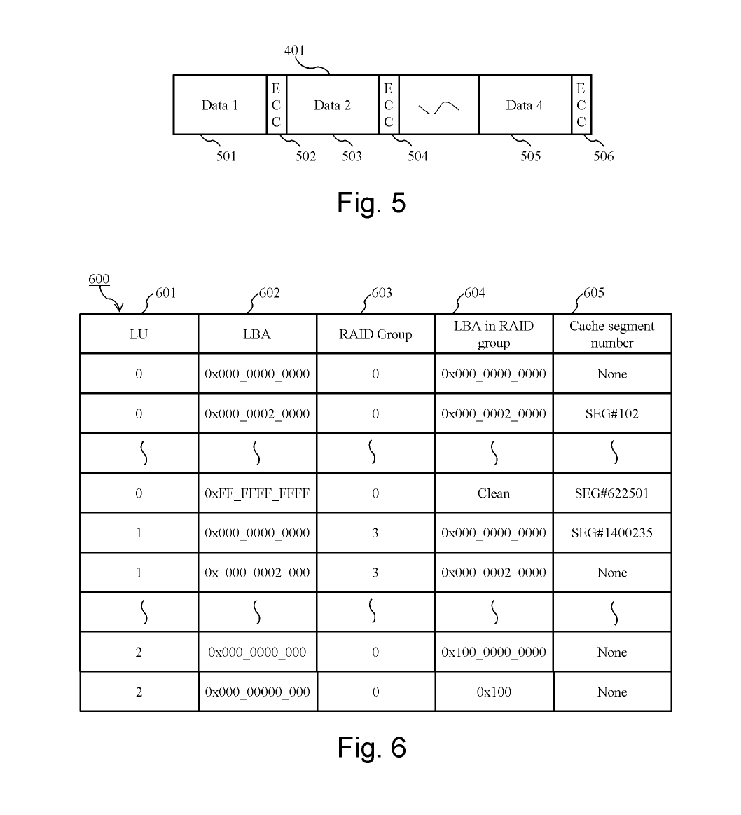

FIG. 5 is an internal block diagram of an FM chip page 401 related to the first example.

Page 401 will be explained here, but the same configuration also applies to the other pages 402 through 407.

The page 401 stores data 501, 503, 505 and so forth having a fixed number of bits (for example, 4 KB). In addition to the data 501, 503, 505, the page 401 stores ECCs 502, 504, 506, which are appended to the respective pieces of data by the FM interface 217. Each ECC 502, 504, 506 and so forth is stored adjacent to the data to be protected (that is, error correction-target data: referred to as protected data). That is, a set of a piece of data and the corresponding ECC are stored as a single unit (ECC CW: ECC CodeWord). Here, a set of the data 501 and the ECC 502, a set of the data 503 and the ECC 504, and a set of the data 505 and the ECC 506 are stored in this drawing. Also, this drawing shows a configuration in which four ECC CWs are stored in one page, but an arbitrary number of ECC CWs tailored to the page size and the strength (number of correctable bits) of the ECC may be stored. A data loss failure here is a phenomenon, which occurs when the number of failed bits per single ECC CW exceeds the number of correctable bits of the ECC comprising this ECC CW.

The configuration of the NVM module 126 and the computer system in which the NVM module 126 is used have been explained hereinabove.

Next, the management information used by the storage apparatus 101 will be explained.

FIG. 6 shows cache hit determination information 600 related to the first example.

The cache hit determination information 600 is stored inside the storage controller (for example, the DRAM 125) of the storage apparatus 101. The cache hit determination information 600, for example, is management information for determining whether or not the reference destination of a read/write command is on the cache when the storage apparatus 101 has received this command from the higher-level apparatus 103. In a case where it has been determined that the command reference destination is not on the cache, the cache hit determination information 600 also manages the reference destination of the storage device (SSD 111, HDD 112).

The cache hit determination information 600 comprises a LU (Logical Unit) 601, a LBA (Logical Block Address) 602, a RAID group 603, an LBA in RAID group 604, and a cache segment number 605 for each LU area. The LU area is an individual area obtained by segmenting the LU into a prescribed size (for example, 128 KB (kilobytes)).

The LU 601 is identification information for a LU. The LU is an individual logical storage area managed by the storage controller 110. The storage apparatus 101 provides a LU to the higher-level apparatus 103. In the higher-level apparatus 103, one LU is recognized and managed as one storage area. The higher-level apparatus 103, upon sending a read/write command, notifies the storage controller 110 of the LU and the LBA, which will be explained further below, so as to specify the target thereof.

The LBA 602 is a logical address, which belongs to a LU area in the LU 601 managed by the storage apparatus 101. The storage apparatus 101, upon receiving a read/write command from the higher-level apparatus 103, acquires a command reference destination in accordance with receiving the LU and the LBA from the higher-level apparatus 103.

FIG. 6 shows an example in which the storage controller 110 manages the LU by segmenting the LU into LU areas of 128 KB each, but in the example of the present invention, the LU management unit is not limited to this unit.

In FIG. 6, it is supposed that the LU is segmented into areas in units of 128 KB, the first address of the area is stored in the LBA 602, and the LBA within a range of 128 KB from the first address corresponds to the LBA 602, but the first address does not always have to be stored in the LBA 602.

The RAID group 603 is identification information for a RAID group (a RAID group based on a LU area) associated with a LU and a LBA specified by the higher-level apparatus 103. The RAID group 603 is configured from either multiple SSDs 111 or HDDs 112 of the same type.

The LBA in RAID group 604 is a LBA (the LBA corresponding to the LU area) inside the RAID group, which is associated with the LU and the LBA specified by the higher-level apparatus 103. When processing a read/write command from the higher-level apparatus 103, the storage apparatus 101 uses this information to acquire the RAID group, which is actually storing the data, and the LBA inside this RAID group from the LU and the LBA acquired from the higher-level apparatus 103.

The cache segment number 605 is the number of the cache segment associated with the LU and the LBA specified by the higher-level apparatus 103. When processing the read/write command, the storage apparatus 101 determines whether the target data of this access is on the cache from the LU and the LBA 602 acquired from the higher-level apparatus 103.

Specifically, for example, in a case where a cache segment number is stored in the cache segment number 605, the processor 121 determines that the reference destination of the LU and the LBA acquired from the higher-level apparatus 103 is on the cache (a cache hit). Alternatively, in a case where a cache segment number is not stored in the cache segment number 605 (equivalent to “none” in FIG. 6), the storage controller 110 determines that the reference destination of the LU and the LBA acquired from the higher-level apparatus 103 is not on the cache (a cache miss).

In a case where the processor 121 has determined that there is a cache hit, the processor 121 acquires an address in the cache area from the cache segment number 605, and implements the read/write processing with respect to this cache area. Alternatively, in a case where the processor 121 has determined that there is a cache miss, the processor 121 implements the read/write processing with respect to an identified area specified in the LBA of the RAID group configured in accordance with the storage device (SSD 111, HDD 112) from the RAID group 603 and the LBA in RAID group 604.

The preceding has been an explanation of the cache hit determination information 600. The cache hit determination information 600 is not limited to the configuration shown in FIG. 6, and may be any configuration as long as it is one that makes it possible to determine whether or not the logical area (LU and LBA) specified from the higher-level apparatus 103 is an access to the cache.

For example, the cache hit determination information 600 may manage only a LU 601 and a LBA 602 without managing all the information of the LU 601 and the LBA 602 provided by the storage apparatus 101 as in this example. In accordance with this, it may be supposed that the processor 121 determines that there is a cache miss for a LU 601 and a LBA 602, which do not exist in the cache hit determination information 600, and the processor 121 performs processing with respect to the storage device.

For example, the processor 121 may make a determination as to a cache hit one time using a bitmap associated with the LU 601 and the LBA 602, compute a hash only for the LBA 601 for which there was a hit, and acquire the cache segment number 605 from the hash value.

In the case of a cache miss, the processor 121 may use different management information in addition to the cache hit determination information 600 to identify a physical access destination in the storage device.

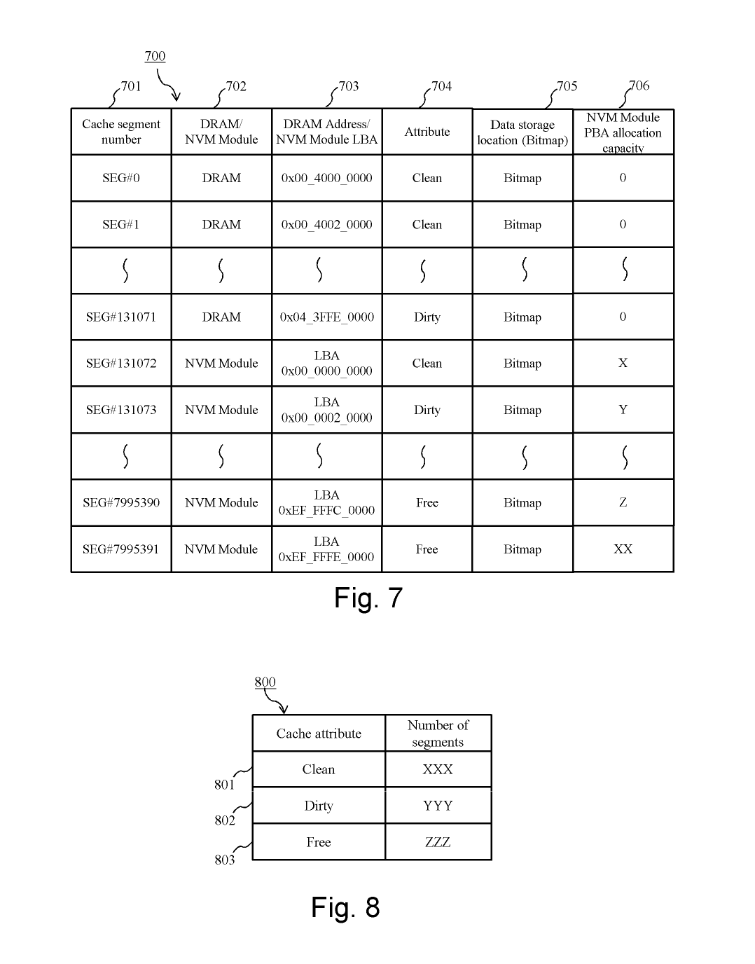

Next, cache segment management information 700 will be explained using FIG. 7.

FIG. 7 shows cache segment management information 700 related to the first example.

The cache segment management information 700 is stored in the storage controller 110 (for example, the DRAM 125). The cache segment management information 700 is management information to be referenced in a case where the processor 121 has determined that there is a cache hit using the cache hit determination information 600.

The processor 121 uses the cache segment number 605 acquired from the cache hit determination information 600 to acquire the LBA of either the DRAM 125 or the NVM module 126, which constitutes the physical storage destination, from the cache segment management information 700.

The cache segment management information 700 comprises a cache segment number 701, a DRAM/NVM module 702, a DRAM Address/NVM module LBA 703, an attribute 704, a data storage location (Bitmap) 705, and a NVM module PBA allocation capacity 706 for each cache segment.

The cache segment number 701 is the number of a cache segment (segment).

The DRAM/NVM module 702 shows the device to which the segment is associated. When the segment is associated with the DRAM 125, the DRAM/NVM module 702 constitutes information showing that the associated device is the DRAM 125. Alternatively, when the segment is associated with the NVM module 126, the DRAM/NVM module 702 constitutes information showing that the associated device is the NVM module 126. Here, “DRAM” is used as the information showing that the associated device is the DRAM 125, and “NVM module” is used as the information showing that the associated device is the NVM module 126.

The DRAM Address/NVM module LBA 703 shows the internal address of either the DRAM 125 or the NVM module 126, which is associated with the segment.

For example, since the DRAM/NVM module 702 for the segment of segment number 0 (SEG #0) is “DRAM”, the internal address shown in the DRAM Address/NVM module LBA 703 is a DRAM address.

Alternatively, since the DRAM/NVM module 702 for the segment of segment number 131073 (SEG #131073) is “NVM module”, the internal address shown in the DRAM Address/NVM module LBA 703 is a NVM module 126 address.

The attribute 704 shows an attribute of the segment shown in the cache segment number 701. In this example, the segment attributes include “clean” (an attribute value signifying that it is a segment in which stored data is stored in the storage device), “dirty” (an attribute value signifying that it is a segment in which unstored data is stored in the storage device), and “free” (an attribute value signifying that it is a segment into which new data can be written). The attribute of the segment of segment number 0 (SEG #0) shows that the segment is “clean”. Similarly, the attribute of the segment of segment number 131073 shows that the segment is “dirty”. A “free” segment is reserved on a priority basis from the storage controller 110, and data is written to the reserved segment.

The data storage location 705 shows the location where data is stored in a segment. Data is not necessarily stored in all of the areas in the segment. For example, the segment size in this example is 128 KB, and in a case where an 8-KB read command has been received from the higher-level apparatus 103, the storage apparatus 101 allocates a 128-KB segment for the 8 KB of data and stores the read data in the allocated segment. At this time, the 8 KB of data is stored in a location that is separated an arbitrary number of bytes from the segment start address (NVM module LBA). To manage this storage area, information showing the place where the actual data is stored in the 128-KB segment is needed. The data storage location 705 manages this information using a bitmap. The segment size in this example is 128 KB, and the management configuration is such that 1 bit is allocated for each 512 B unit of cache area. Thus, the data storage location 705 manages the data stored in the segment using 128 KB/512 B=256 bits of information. In the above-mentioned example of storing 8 KB of data, a 1 is stored in 8 KB/512 B=16 bits of a 256 bit bitmap to show that data is being stored, and a 0 is stored in the remaining 256 bits-16 bits=240 bits of the bitmap to show that data is not being stored.

The NVM module PBA allocation capacity 706 shows the total capacity of a physical area allocated to the segment. The storage controller 110 is notified of the NVM module PBA allocation capacity 706 by the NVM module 126.

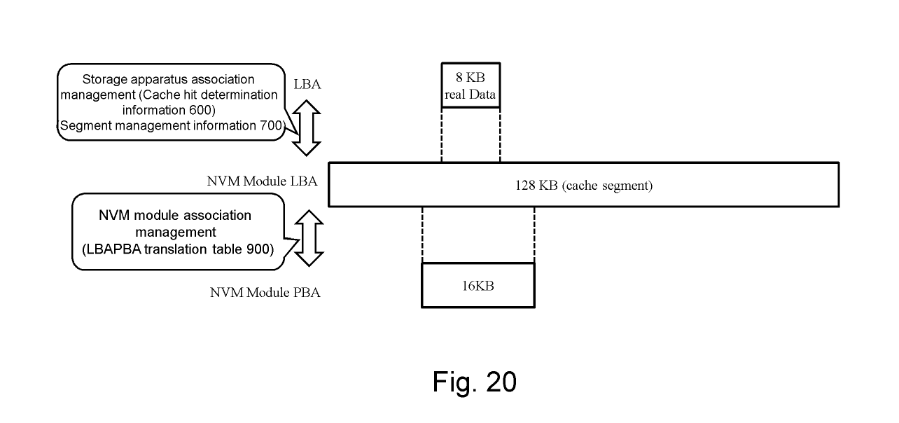

For example, in a case where the segment size is 128 KB, the storage controller 110, upon receiving the 8-KB read command from the higher-level apparatus 103, allocates a 128-KB NVM module LBA as the segment to be used for storage. At this time, the NVM module 126 allocates a NVM module PBA of sufficient capacity to store 8 KB, which is the amount of data to be stored, with respect to the 128-KB NVM module LBA. For example, as shown in FIG. 20, in a case where an association management unit for the NVM module LBA and the NVM module PBA of the NVM module 126 is 16 KB, the storage controller 110 (the processor 215) associates a 16-KB NVM module PBA with the NVM module LBA of a 128-KB segment allocated for storing the 8 KB of data. Therefore, the value of the NVM module PBA allocation capacity 706 at this time is 16 KB.

The NVM module PBA allocation capacity 706 may be a physical storage area assumed to be for the processor 215 to store data in the NVM module 126. Furthermore, the PBA allocation capacity 706 may be the physical storage area actually allocated when the processor 215 stores sent data in the NVM module 126.

The NVM module PBA allocation capacity 706 becomes either “invalid” or “0” for a segment, which is associated with the DRAM.

The cache segment management information 700 has been explained hereinabove. FIG. 8 shows cache attribute number management information 800 related to the first example.

The cache attribute number management information 800 is stored in the storage controller 110 (for example, in the DRAM 125). The cache attribute number management information 800 is for managing the distribution of cache segments managed by the storage apparatus 101.

The cache attribute number management information 800 comprises a value denoting a number of segments for an attribute with respect to each of multiple attributes 801 through 803 of a cache segment.

The attributes for all the segments managed by the storage apparatus 101 are stored in the segment attributes 801 through 803. The segment attributes include clean 801, dirty 802, and free 803. The number of segments for each attribute is stored as the number value.

Specifically, the number in clean 801 shows the number of segments for which the attribute is clean. The clean attribute shows that the same data as the data stored in the cache is also stored in the storage device (SSD 111, HDD 112). Since the data is able to be read from the storage device even when the data has been erased from the cache, the processor 121 can arbitrarily cancel the association between the segment and the LU and LBA.

For example, when the attribute of a segment, which is not accessed at fixed periods, is clean, the processor 121 can cancel the association between the segment and the LU and LBA in accordance with rewriting the cache segment number 605 in the corresponding row of the LU and LBA in the cache hit determination information 600 to “none”. Generally speaking, this process is called “segment release”. The processor 121, for example, is able to enhance the probability of a cache hit in accordance with releasing a segment to which there has been relatively no access and storing data of a more frequently accessed area in the segment.

The number in the dirty 802 shows the number of segments for which the attribute is dirty. The dirty attribute shows that the same data as the data stored in the cache is not stored in the storage device (SSD 111, HDD 112).

For example, in a case where a data update has been performed on the cache and new data has been stored in the cache but not stored in the storage device (SSD 111, HDD 112), the data stored in the storage device (SSD 111, HDD 112) becomes old data. In accordance with this, even though the cache segment is associated with the same LU and LBA, the data stored in the cache and the storage device (SSD 111, HDD 112) are different, and the new data will be lost when the data in the cache is erased. Therefore, the processor 121 is not able to release a segment for which access is not performed at fixed periods when the attribute for this segment is dirty. Thus, in a case where the dirty attribute segments have become equal to or larger than a fixed amount, the processor 121, when the access load on the storage apparatus 101 is low, makes the data, which is stored in the dirty attribute segment to the storage device (SSD 111, HDD 112), the same as data stored the storage device (SSD 111, HDD 112) and converts the attributes of the segments to clean. This process will be called “segment cleaning” hereinbelow.

The number in the free 803 shows the number of segments for which the attribute is free. The free attribute shows that data is not stored in the segment.

The processor 121 uses the cache attribute number management information 800 to reserve as a pool a fixed amount of free attribute segments for caching write data immediately. Specifically, for example, when the amount of free-attribute segments becomes equal to or less than a predetermined threshold, the processor 121 is able to increase the amount of free-attribute segments so as to exceed the threshold in accordance with releasing a clean-attribute segment and changing the attribute of the segment to free.

The cache attribute number management information 800 has been explained hereinabove. In this example, the configuration is such that only the three types of attributes of “clean”, “dirty”, and “free” are shown as segment attributes, but the segment attributes are not limited to these three types. That is, the segment attribute may be an attribute other than clean, dirty, or free.

The storage apparatus 101 (the processor 121) manages the cache by using the cache hit determination information 600, the cache segment management information 700, and the cache attribute number management information 800 described hereinabove.

Next, management information used to control the NVM module 126 will be explained.

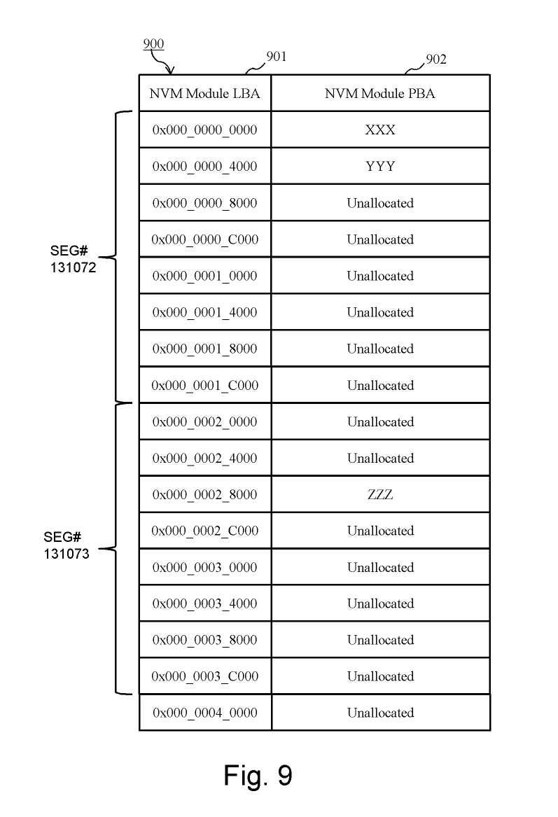

FIG. 9 shows an LBA-PBA translation table 900 related to the first example.

The LBA-PBA translation table 900 is stored in the NVM module 126 (for example, the RAM 213). The LBA-PBA translation table 900 comprises a NVM module LBA 901 and a NVM module PBA 902 for each LBA.

The processor 215, upon receiving a NVM module LBA included in a read/write command from a higher-level device (the storage controller 110), uses the LBA-PBA translation table 900 to acquire from this NVM module LBA the NVM module PBA 902 showing the place where the data is actually stored.

According to this process, when overwriting and updating data, a write command to the same NVM module LBA can be written to a different NVM module PBA. After this write, it is possible to overwrite data in a non-overwritable nonvolatile memory in accordance with allocating the NVM module PBA storing the latest updated data to the NVM module LBA.

In this example, the processor 215 uses the LBA-PBA translation table 900 to strive for efficient use of the physical storage area of the NVM module 126 in accordance with allocating the NVM module PBA only to the NVM module LBA area where data exists.

The NVM module LBA 901 shows an area obtained by segmenting a virtual logical area provided by the NVM module 126 into units of 16 KB (the 16 KB-segmented areas here are arranged in order from the lowest address).

This shows that this example manages the association between the NVM module LBA and the NVM module PBA in units of 16 KB. However, this does not indicate that the association between the NVM module LBA and the NVM module PBA is limited to being managed in units of 16 KB. This management unit may be any unit as long as it is smaller in size than the size of the segment (the smallest unit of storage controller 110 access to the NVM module 126).

In the example shown in FIG. 9, the segment size is 128 KB, and the association between the NVM module LBA and the NVM module PBA is managed in units of 16 KB. That is, one storage apparatus 101 segment here is configured from eight NVM module LBAs.

The NVM module PBA 902 is information showing the area of all the FM chips (220 through 228) managed by the NVM module 126.

In this example, the NVM module PBA 902 has addresses, which have been segmented into page units, which is the smallest unit for accessing the FM chips (220 through 228).

In the example of FIG. 9, a certain PBA value called “XXX” is associated as the PBA (Physical Block Address) associated with the NVM module LBA 901 “x 000_0000_{—}0000”. This PBA value is an address, which uniquely shows the storage area of a certain FM (220 through 228) of the NVM module 126. For example, in a case where the NVM module LBA 901 “0 x 000_{—}0000_{—}0000” has been received as the reference destination of a read command from the storage controller 110, the physical data is acquired from the NVM module PBA 902 “XXX” within the NVM module 126.

In a case where there is no NVM module PBA 902 associated with the NVM module LBA 901, the NVM module PBA 902 becomes “unallocated”. For example, in the example of FIG. 9, of the eight NVM module LBAs associated with the segment number SEG #131073, data is actually being stored only in the 16-KB area of NVM module PBA “zzz”, which is associated with the NVM module LBA “0 x 000 0002 8000”. The other NVM module PBA 902 are “unallocated”.

This example is aimed at enhancing the utilization efficiency of the storage area in the NVM module 126, and is characterized by the fact that it makes the capacity of the NVM module LBA, which is a logical area, larger than the total allocation capacity of the NVM module PBA 902.

In this example, the total size of the NVM module LBA 901, which is the logical area, is regarded as a constant factor of the total size of the NVM module PBA 902. Regarding a scaling factor for this, in this example, a ratio of the smallest management unit of the segment to the smallest logical-physical translation unit is used as the scaling factor.

Since the smallest segment management unit in this example is 128 KB and the smallest logical-physical translation unit is 16 KB, the scaling factor is eight times 128 KB/16 KB. Thus, in this example, when the total allocation capacity of the NVM module PBA is 100 GB, the NVM module LBA is 100 GB×8 =800 GB.

In this example, in a case where the NVM module 126 is coupled to the storage apparatus 101, the storage apparatus 101 acquires the smallest management unit of the LBA-PBA translation table 900 from the NMV module 126. The NVM module 126 acquires the smallest segment management unit of the storage controller 110 from the storage controller 110.

At this time, either the NVM module 126 or the storage controller 110 computes the ratio of the smallest management unit of the segment to the smallest logical-physical translation unit, and based on this value, decides the total size of the NVM module LBA 901 (the capacity of the logical space of the NVM module 126).

In this example, an example in which the total size of the NVM module LBA 901 is regarded as a constant factor of the total allocation capacity of the NVM module PBA is described, but this example is not limited to this formula.

In this example, the NVM module capacity utilization efficiency is improved in accordance with increasing the total size of the NVM module LBA 901 to exceed the total allocation capacity of the NVM module PBA. The reason for this improvement will be explained hereinbelow.

In this example, as shown in FIG. 9, only the NVM module LBA 901 having data is associated with the NVM module PBA 902. Thus, for example, when only 16 KB of data is stored in the segment, one NVM module PBA 902 is allocated to one NVM module LBA 901 in the 128-KB segment. As a result, a NVM module PBA 902, which originally would have been allocated, is unallocated, and the physical capacity utilization efficiency of the NVM module 126 decreases.

In a case where the associated NVM module LBA 901 differs from the unallocated NVM module PBA 902, the physical storage area can be used effectively. Thus, when the total size of the NVM module LBA 901 is expanded to more than the total allocation capacity of the NVM module PBA 902, data of a size that is smaller than the segment size can be stored in a segment, making it possible to allocate an unallocated NVM module PBA 902 to another NVM module LBA 901, and to improve the utilization efficiency of the physical storage area.

In other words, it is possible to improve the utilization efficiency of the physical storage area by managing the relationship between the NVM module LBA 901 and the NVM module PBA 902 in accordance with the LBA-PBA translation table 900 shown in FIG. 9 so as to associate only areas in which storage data actually exists, and expanding the total size of the NVM module LBA 901 to exceed the total allocation capacity of the NVM module PBA 902.

However, the capacity of the NVM module PBA 902 associated with the NVM module LBA 901 will change in a case where 128 KB of data is stored in a 128-KB size segment and in a case where 16 KB of data is stored in a 128-KB size segment. That is, since unallocated NVM module PBA 902 will occur in abundance when there are large quantities of segments storing small-size data, the size of the usable NVM module LBA 902 can be expanded. Alternatively, since the unallocated NVM module PBA 902 decrease when there is an abundance of segments in which the size of the data is the same as the segment size, the size of the NVM module LBA 901 must not be expanded more than the NVM module PBA 902. Thus, the total size of the usable NVM module LBA 901 substantially changes in accordance with the size of the data stored in the segment.

In this example, the storage controller 110 changes the total size of the usable NVM module LBA 901 by regarding the total size of an expanded NVM module LBA 901 as being fixed and variably controlling the usable physical capacity of the segment, which is configured from the NVN module LBA 901. The control of the use of this segment will be explained in detail further below.

The LBA-PBA translation table 900 used by the NVM module 126 has been explained hereinabove. Various information may be explained using the expression “aaa table”, but the various information may be expressed using a data structure other than a table. To show that the information is not dependent on the data structure, “aaa table” can be called “aaa information”.

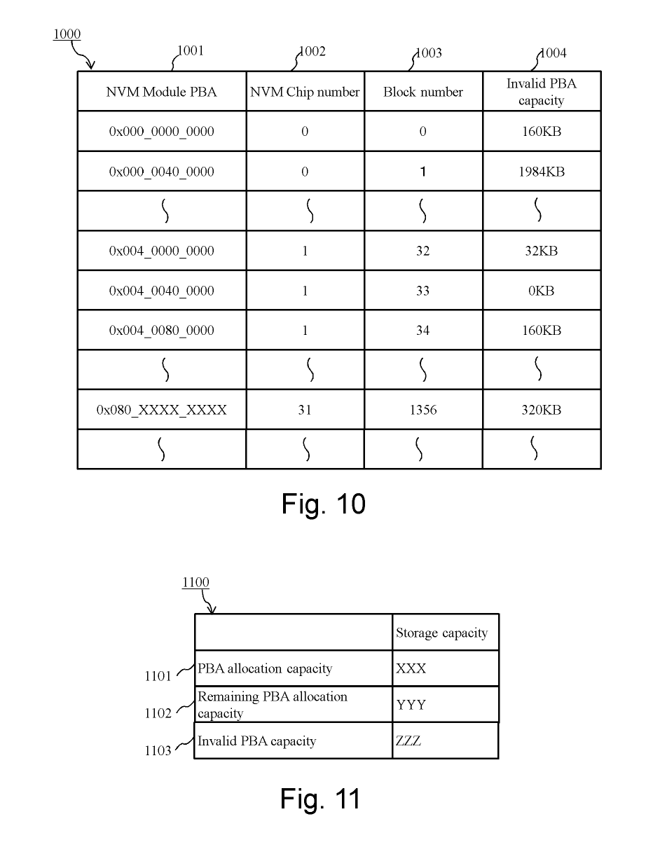

Next, block management information used by the NVM module 126 will be explained using FIG. 10.

FIG. 10 shows block management information 1000 related to the first example.

The block management information 1000 is stored in the RAM 213 of the NVM module 126. The block management information 1000 comprises a NVM module PBA 1001, a NVM chip number 1002, a block number 1003, and an invalid PBA capacity 1004 for each physical block in the NVM module 126.

The NVM module PBA 1001 shows information for uniquely identifying a physical block in an FM chip (220 through 228). In this example, the NVM module PBA is managed in units of blocks. In FIG. 10, the NVM module PBA 1001 is the first address of the physical block. For example, “0x000_{—}0000_{—}0000” shows that the physical block is equivalent to a NVM module PBA range of “0x000_{—}0000_{—}0000” through “0x000_{—}003F FFFF”.

The NVM chip number 1002 shows the number of the FM chips (220 through 228) comprising the physical block.

The block number 1003 shows the number of the physical block.

The invalid PBA capacity 1004 shows the total capacity of an invalid page in the physical block. In this specification, a physical page in which no data is written may be called a “free page”. Regarding logical pages, recently written data may be called “valid data”, and data, which has become old data as a result of valid data having been written, may be called “invalid data”. A physical page in which valid data is stored may be called “valid page”, and a physical page in which invalid data is stored may be called “invalid page”. In this example, either an invalid page or the PBA thereof may be called “invalid PBA”, and either a valid page or the PBA thereof may be called “valid PBA”.

The invalid PBA inevitably occurs when an attempt is made to realize an overwrite in a nonvolatile memory for which a data overwrite is not possible. Specifically, at data update time, the updated data is stored in another unwritten PBA, and the NVM module PBA 902 of the LBA-PBA translation table 900 is rewritten to the first address of the PBA area in which the update data is stored. At this time, the association resulting from the LBA-PBA translation table 900 is cancelled, and the NVM module PBA 902 in which the pre-update data is being stored becomes an invalid PBA.

The example of FIG. 10 shows that the invalid PBA capacity 1004 of the NVM module 126-managed block having “0” in the NVM chip number 1002 and “0” in the block number 1003 is 160 KB.

In this example, when the invalid PBA capacity 1103 in NVM module 126-managed PBA allocation management information 1100, which will be explained further below, becomes larger than a threshold (when the free pages have run out), data is erased from the block comprising the invalid PBA, and an unwritten PBA area (that is, a free physical block) is created. This process is called reclamation. When the valid PAB is included an erase-target block during this reclamation, it becomes necessary to copy valid data from the valid PBA. A valid data copy involves a write process to the FM chips (220 through 228), and as such, shortens the life of the FM chips (220 through 228) and, in addition, causes a drop in the performance of the storage apparatus 101 due to the consumption of resources, such as the NVM module 126 processor 215 and bus bandwidth, used in the copy process. Thus, it is desirable that there be as few valid data copies as possible. The NVM module 126 of this example can reference the block management information 1000 at reclamation time to reduce the amount of valid data to be copied in accordance with treating a block having a large invalid PBA capacity 1004 (a block comprising an abundance of invalid PBAs) as an erase-target block.

In this example, the invalid PBA capacity 1004 is regarded as the total capacity of an invalid page, but the present invention is not limited thereto. For example, the invalid PBA capacity 1004 may be the number of invalid pages.

The block management information 1000 used by the NVM module 126 has been explained hereinabove.

FIG. 11 shows PBA allocation management information 1100 related to the first example.

The PBA allocation management information 1100 is stored in the NVM module 126 (for example, the RAM 213). The PBA allocation management information 1100 comprises a PBA allocation capacity 1101, a remaining PBA allocation capacity 1102, and an invalid PBA capacity 1103.

The PBA allocation capacity 1101 shows the total capacity of the NVM module PBA 902 associated with the NVM module LBA 901 in accordance with the LBA-PBA translation table 900 (that is, the total capacity of the physical blocks allocated to multiple logical blocks comprising a logical space).

The remaining PBA allocation capacity 1102 shows a value obtained by subtracting the PBA allocation capacity 1101 from the total capacity of the PBA configured from the FM chips (220 through 228).

The invalid PBA capacity 1103 shows the capacity of the PBA that has become an invalid PBA from among the PBAs managed by the NVM module 126. The NVM module 126 of this example, for example, in a case where this value has become larger than a threshold, implements the reclamation described hereinabove to make the invalid PBA capacity 1004 equal to or less than a fixed value.

In this example, in a case where there has been an update in the PBA allocation management information 1100, the NVM module 126 sends the post-update PBA allocation management information 1100 (at least the post-update information part) to the storage controller 110.

The PBA allocation management information 1100 has been explained hereinabove.

The NVM module 126 of this example uses the LBA-PBA translation table 900, the block management information 1000, and the PBA allocation management information 1100 described hereinabove to manage the cache storage area.

Next, the cache control of the storage apparatus 101 will be explained.

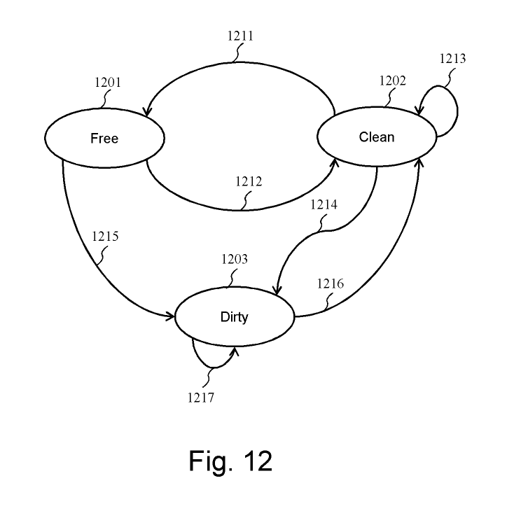

FIG. 12 is a conceptual drawing depicting transitions of segment attributes in the cache control related to the first example.

The conditions of the respective transitions 1211 through 1217 will be explained below.

˜Segment Attribute Transition 1211 From Clean to Free˜

The transition 1211 of the segment attribute from clean to free is performed by the processor 121 of the storage controller 110 when the “remaining allocation capacity of the NVM module PBA” becomes equal to or less than a prescribed threshold.

The “remaining allocation capacity of the NVM module PBA”, which is used as the judgment criterion for this transition 1211, may be the remaining PBA allocation capacity 1102 of the PBA allocation management information 1100 managed by the NVM module 126, or may be determined by calculating the sum total of the NVM module PBA allocation capacity 706 of the cache segment management information 700 managed by the storage apparatus 101 as the number of NVM module PBA allocations, and subtracting this value from the all the PBAs in the NVM module 126.

When the “remaining NVM module PBA allocation capacity” becomes equal to or less than a prescribed threshold, the storage controller 110 (processor 121) decides on a (release-target) segment, which is to be configured to a free attribute (for example, a segment for which the longest time period has elapsed since last being accessed) from among a group of clean-attribute segments.

At this time, the storage controller 110 (processor 121) uses the number of the decided release-target segment to reference the cache segment management information 700 and acquire the NVM module PBA allocation capacity 706 of the release-target segment. The processor 121 changes the attribute 704 of the release-target segment from “clean” to “free”, and adds the released NVM module PBA capacity to the “remaining NVM module PBA allocation capacity”.

When the result of this addition is that the “remaining NVM module PBA allocation capacity” exceeds the prescribed threshold, the release of the segment ends. Alternatively, in a case where the “remaining NVM module PBA allocation capacity” is equal to or less than the prescribed threshold as before, the storage controller 110 (processor 121) releases another segment. In this way, the processor 121 continues to change a clean-attribute segment to a free-attribute segment until the “remaining NVM module PBA allocation capacity” exceeds the prescribed threshold.

At the transition 1211 of the segment attribute from clean to free, the storage controller 110 (processor 121) also references the cache hit determination information 600 stored in the DRAM 125 and changes the cache segment number 605 corresponding to the segment, which was changed to the free attribute, to “none”.

˜Segment Attribute Transition 1213 From Clean to Clean˜

The transition 1213 of the segment attribute from clean to clean is implemented when the data (hereinafter, segment data) in a segment, which is caching read-target data, is updated, and, in addition, this segment data has been copied to the storage device (SSD 111, HDD 112).

Since a change is likely to occur in the remaining PBA capacity in accordance with the segment data being updated, the storage controller 110 (processor 121) either acquires the remaining PBA allocation capacity 1102 from the NVM module 126, or calculates the remaining PBA allocation capacity using the NVM module PBA allocation capacity 706 in the cache segment management information 700.

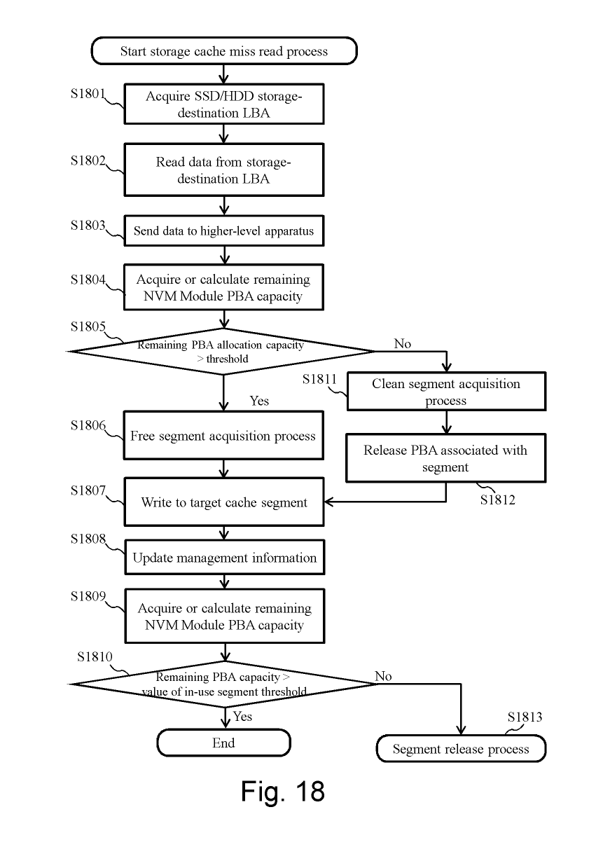

In this example, when the attribute of the segment, which is associated with the NVM module LBA 901, transitions from clean to clean, and the LU and LBA, which are associated with the segment, change, the storage controller 110 (processor 121) notifies the NVM module 126 of the NVM module LBA associated with the segment, and releases all the NVM module PBA associated with the NVM module LBA of this segment (corresponds to S1812 of FIG. 18).

˜Segment Attribute Transition 1214 From Clean to Dirty˜

The transition 1216 of the segment attribute from clean to dirty is implemented when the segment data in the segment, which is caching write-target data (hereinafter, write data), is updated.

Since a change is likely to occur in the remaining PBA capacity in accordance with the segment data being updated, the storage controller 110 (processor 121) either acquires the remaining PBA allocation capacity 1102 from the NVM module 126, or calculates the remaining PBA allocation capacity using the NVM module PBA allocation capacity 706 in the cache segment management information 700.

˜Segment Attribute Transition 1217 From Dirty to Dirty˜

The transition 1217 of the segment attribute from dirty to dirty is implemented when the segment data in the segment, which is caching write data, is updated without being copied to the storage device (SSD 111, HDD 112). Since a change is likely to occur in the remaining PBA capacity in accordance with the segment data being updated, the storage controller 110 (processor 121) either acquires the remaining PBA allocation capacity 1102 from the NVM module 126, or calculates the remaining PBA allocation capacity using the NVM module PBA allocation capacity 706 in the cache segment management information 700.

˜Segment Attribute Transition 1216 From Dirty to Clean˜

The transition 1216 of the segment attribute from dirty to clean is implemented when the segment data has been copied to the storage device (SSD 111, HDD 112). In accordance with this, since the segment data is not updated and the remaining PBA capacity does not change, the processor 121 does not update of the remaining PBA capacity.

˜Segment Attribute Transition 1212 From Free to Clean˜

The transition 1212 of the segment attribute from free to clean is implemented when the read-target data has been stored in the free-attribute segment.

Since a change is likely to occur in the remaining PBA capacity in accordance with the read-target data having been stored in the segment, the storage controller 110 (processor 121) either acquires the remaining PBA allocation capacity 1102 from the NVM module 126, or calculates the remaining PBA allocation capacity using the NVM module PBA allocation capacity 706 in the cache segment management information 700.

˜Segment Attribute Transition 1215 From Free to Dirty˜

The transition 1215 of the segment attribute from free to dirty is implemented when write data has been written to a segment, which had been a free-attribute segment.

Since a change is likely to occur in the remaining PBA capacity in accordance with the write data having been stored in the segment, the processor 121 of the storage controller 101 either acquires the remaining PBA allocation capacity 1102 from the NVM module 126, or calculates the remaining PBA allocation capacity using the NVM module PBA allocation capacity 706 in the cache segment management information 700.

The transitions of the segment attributes has been explained hereinabove. The attribute of a segment in is example is not limited solely to the three types of clean, free, and dirty. This example can also be applied to a case in which there exists more segment attributes than the three, to include clean, free, and dirty.

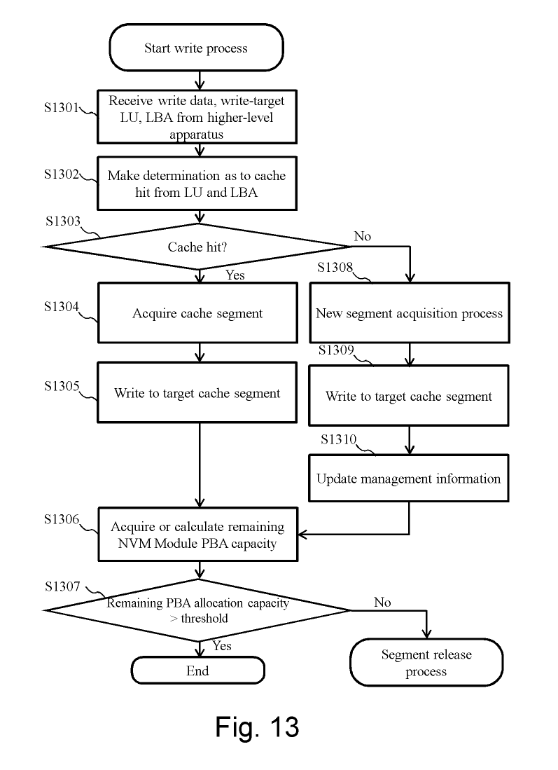

Next, a write process of the storage apparatus 101 will be explained using FIG. 13.

FIG. 13 shows an example of a write process of the storage apparatus 101 related to the first example.

In S1301, the storage controller 110 receives write data and an address (LU and LBA) where this write data is to be stored from a server or other such higher-level apparatus 103.

In S1302, the storage controller 110 uses the LU and the LBA received from the higher-level apparatus 103 in S1301 to make a determination as to a cache hit. Specifically, for example, the processor 121 references the cache hit determination information 600 stored in the DRAM 125 inside the storage controller 110, and acquires the value in the cache segment number 605 identified by the LU and the LBA from the higher-level apparatus 103. The storage controller 110, in a case where the acquired value is a segment number, determines that there is a cache hit. Alternatively, in a case where the acquired value in not a segment number, the storage controller 110 determines that there is a cache miss.

In S1303, the storage controller 110 implements processing based on the cache hit determination result in S1302. In a case where the determination result in S1302 is a cache hit (S1303: Yes), the storage controller 110 performs the processing of S1304. Alternatively, in a case where the determination result in S1302 is a cache miss (S1303: No), the storage controller 101 performs the processing of S1308.

In S1304 (S1303: Yes), the storage controller 110 acquires detailed information on a cache segment, which has already been allocated. Specifically, for example, the processor 121 references the cache segment management information 700 stored in the DRAM 125 inside the storage controller 110, and acquires the values in the DRAM/NVM module 702 and the DRAM/Address/NVM module LBA 703 of the cache segment number 605 (701) acquired in S1302.

In S1308 (S1303: No), the storage controller 110 acquires a new segment. The storage controller 110 references the attribute 704 of the cache segment management information 700, and selects an arbitrary segment from among the segments having the attribute free as a segment for caching the write data. The storage controller 110 acquires detailed information on the cache segment from the acquired cache segment number 605 (701). Specifically, for example, the processor 121 references the cache segment management information 700 stored in the DRAM 125 inside the storage controller 110, and acquires the values in the DRAM/NVM module 702 and the DRAM/Address/NVM module LBA 703 of the target segment selected from among the segments having “free” in the attribute 704.

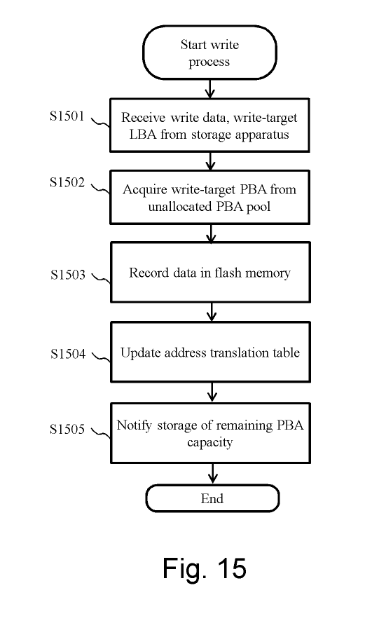

In S1305 and S1309, the storage controller 110 writes the write data to the target cache segment. In this example, there exist two types of segments, i.e., a segment associated with the DRAM 125 and a segment associated with the NVM module 126. In the case of a segment associated with the DRAM 125, the storage controller 110 writes the write data received from the higher-level apparatus 103 to an identified area of the DRAM shown by the DRAM Address value acquired in either S1304 or S1309. Alternatively, in the case of a segment associated with the NVM module 126, the storage controller 110 sends the write data received from the higher-level apparatus 103 to the NVM module 126 together with the value of the NVM module LBA acquired in either S1304 or S1308. The NVM module 126, upon receiving the write data and the NVM module LBA from the storage controller 110, implements the write process shown in FIG. 15. A detailed explanation of the NVM module 126 write process shown in FIG. 15 will be given further below.

In S1306, the storage controller 110 either acquires or calculates the remaining NVM module PBA capacity. Specifically, for example, the processor 121 acquires the PBA allocation management information 1100 from the NVM module 126, and acquires the value of the remaining PBA allocation capacity 1102 from therein. Or, the processor 121 references the cache segment management information 700, and stores and updates the PBA allocation capacity of the segment to which the write was performed in S1305 in the NVM module PBA allocation capacity 706 of the cache segment management information 700. Then, the processor 121 calculates the sum total of the NVM module PBA allocation capacity 706 in the cache segment management information 700 as the number of NVM module PBA allocations, subtracts the calculated value from the total NVM module PBA allocation capacity of the NVM module 126, and calculates the remaining PBA allocation capacity. This step is only implemented in a case where the write data has been written to the segment associated with the NVM module 126 in S1305, and need not be implemented in a case where the write data has been written to the segment associated with the DRAM 125.

In S1307, the storage controller 110 determines whether or not the new remaining NVM module PBA allocation capacity either calculated or acquired in S1306 is larger than a predetermined threshold.

When the remaining NVM module PBA allocation capacity is larger than the predetermined threshold, the NVM module PBA allocation capacity has room to spare and a segment release process is not necessary, and the storage controller 110 ends the write process. Alternatively, when the remaining NVM module PBA allocation capacity is equal to or less than the threshold, the NVM module PBA allocation capacity has begun to run out, and as such, the storage controller 110 implements a segment release process.

In S1310, the storage controller 110 updates the management information for managing the association between the segment to which the write data was written in S1309 and the LU and the LBA received from the higher-level apparatus 103 in S1301. Specifically, for example, the processor 121 references the cache hit determination information 600 stored in the DRAM 125, and updates the value of the cache segment number 605 in the row corresponding to the LU and the LBA acquired in S1301 to the segment number of the segment, which was newly acquired in S1308. According to this process, the newly allocated segment is associated with the LU and the LBA.

The write process of the storage controller 110 has been explained hereinabove. This example does not show the management of information related to an access to a segment (hereinafter, access information), but the management of access information is also included in this example. For example, the storage apparatus 101 can also manage access information, such as a relatively low frequency of access to a segment and/or a long elapsed time period from the last access to a segment.

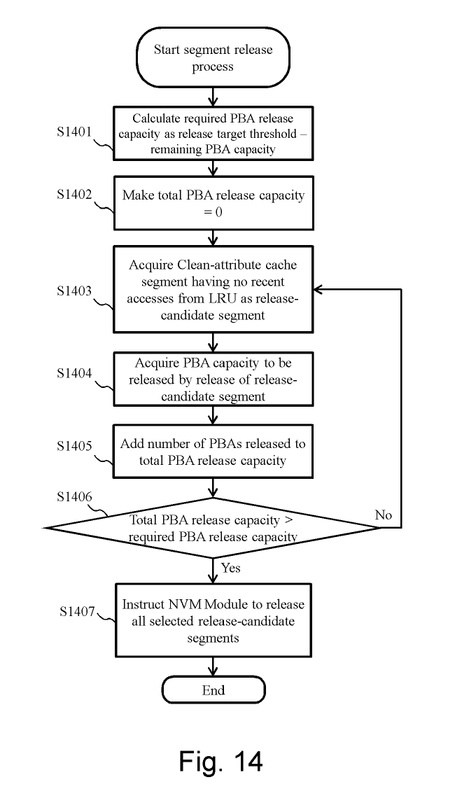

Next, a segment release process of the storage controller 110 will be explained using FIG. 14.

FIG. 14 shows an example of a segment release process of the storage controller 110 related to the first example.

The segment release process of the storage controller 110 in the first example is implemented by the processor 121 in a case where the NVM module 126 notifies the processer 121 of the value in the remaining PBA allocation capacity 1102 of the PBA allocation management information 1100, and the notified remaining PBA allocation capacity 1102 is equal to or less than a predetermined threshold.

A case in which the remaining PBA allocation capacity 1102 of the NVM module 126 is equal to or less than the predetermined threshold, for example, denotes that the NVM module PBA for allocation to a virtually expanded NVM module LBA are starting to run out, and the number of in-use segments associated with the NVM module LBA must be reduced. Thus, in this example, the processor 121 releases clean-attribute segments (creates free-attribute segments) until the remaining PBA allocation capacity 1102 of the NVM module 126 is larger than the threshold.

In S1401, which is the first step of the storage apparatus 101 segment release process, the storage controller 110 calculates the required segment (required NVM module PBA) release capacity. Specifically, for example, the processor 121 first compares a predetermined threshold (a predetermined remaining PBA allocation capacity) to the current remaining PBA allocation capacity. Then, in a case where the current remaining PBA allocation capacity is equal to or less than the predetermined threshold, the processor 121 decides the required segment (required NVM module PBA) release capacity so that the current remaining PBA allocation capacity becomes larger than the predetermined threshold.

In S1402, the storage controller 110 initializes the total PBA release capacity to 0. Here, the total PBA release capacity shows the PBA allocation capacity, which can no longer be allocated to a segment in accordance with the processor 121 releasing the segment.

In S1403, the storage controller 110 acquires as a release-candidate segment (hereinafter, release-candidate segment) a clean-attribute segment having either no recent accesses or a relatively low access frequency based on the LRU. In this example, the storage controller 110 manages the clean-attribute segment using the LRU and selects a segment having the longest elapsed time period after last being accessed as the release-candidate segment. However, this example is not limited to the method for selecting the release-candidate segment based on the LRU. This example is also applicable to any segment management method that enhances the probability of a cache hit. A clean-attribute segment to be used as a release candidate may be selected using an arbitrary algorithm for an arbitrary criterion of an arbitrary segment management method.

In S1404, the storage controller 110 acquires the PBA allocation capacity to be released in accordance with releasing the release-candidate segment selected in S1403. Specifically, for example, the processor 121 references the cache segment management information 700 and acquires the value in the NVM module PBA allocation capacity 706 for the release-candidate segment selected in S1403.

In S1405, the storage controller 110 adds the NVM module PBA release capacity to actually be released in accordance with the release of the release-target segment acquired in S1404 to the total PBA release capacity initialized in S1402.

In S1406, the storage controller 110 judges whether the total PBA release capacity of the total NVM module PBA release capacity calculated in S1405 is equal to or larger than the required NVM module PBA release capacity calculated in S1401. The fact that the total PBA release capacity calculated in S1405 is larger than the required NVM module PBA release capacity calculated in S1401 signifies that a segment release candidate required for making the remaining NVM module PBA allocation capacity larger than the threshold was able to be reserved. In accordance with this, the processor 121 performs the processing of S1407. Alternatively, the fact that the total PBA release capacity calculated in S1405 is less than the required NVM module PBA release capacity calculated in S1401 signifies that the remaining NVM module PBA allocation capacity will not be made larger than the threshold even though the release-candidate segment selected in S1403 is released. Thus, the processor 121 performs the processing of S1403 once again to select an additional release segment.

According to the processing of S1403 through S1406, the storage controller 110 is able to select a segment(s) having the capacity required for making the remaining NVM module PBA allocation capacity larger than the predetermined threshold.

For example, in a case where the capacity of the required NVM module PBA calculated in S1401 is 64 KB, when the NVM module PBA capacity allocated to the segment initially selected in S1403 is 32 KB, the 64 KB will not be satisfied, and as such, the processor 121 repeats the processing of S1403 to acquire another segment for release.

When the NVM module PBA capacity allocated to the segment selected next is 48 KB, the NVM module PBA capacity to be released, combined with the previously selected segment, becomes 32+48=80 KB, and the processor 121 performs the processing of S1407 to satisfy the required NVM module PBA capacity.

In S1407, the storage controller 110 releases the selected release-candidate segment. Specifically, for example, the processor 121 references the cache hit determination information 600 and erases the information of the release-candidate segment associated with the LU and the LBA. Next, the processor 121 notifies the NVM module 126 of the NVM module LBA (start address and size) of multiple release-candidate segments, and instructs the NVM module 126 to release the segments. The NVM module 126 processor 215, which received the indication, references the LBA-PBA translation table 900 and configures all the items in the multiple NVM module PBA 902 associated with the area corresponding to the notified NVM module LBA to “un-allocated”. In addition, the NVM module processor 215 references the block management information 1000 and adds the invalid PBA capacity 1004 of the NVM module PBA for which the association with the NVM module LBA was cancelled to the block management information 1000.

An example of the segment release process of the storage apparatus 101 has been explained hereinabove. Next, a NVM module 126 write process of this example will be explained using FIG. 15.

FIG. 15 shows an example of a NVM module 126 write process related to the first example.

In S1501, the NVM module 126 (FM controller 210) receives write data and the NVM module LBA as the address of the write destination from the storage controller 110.

In S1502, the FM controller 210 acquires a PBA from the unallocated NVM module PBAs for storing the write data. Specifically, for example, the FM controller 210 (processor 215) internally reserves an unallocated NVM module PBA area as a pool, and from therewithin acquires a NVM module PBA, which will be the write target in accordance with a prescribed rule (for example, being associated with a block having a small number of erases).

In S1503, the FM controller 210 stores the write data in a physical page of the NVM module PBA selected as the write target in S1502.

In S1504, the FM controller 210 associates the NVM module PBA selected as the write target in S1502 with the NVM module LBA received from the storage controller 110 in S1501. Specifically, for example, the processor 215 references the LBA-PBA translation table 900 stored in the RAM 213 inside the NVM module 126, and updates the NVM module LBA 901 received from the storage apparatus 101 in S1501 to the NVM module PBA 902 selected as the write target in S1502. In addition, the processor 215 references the PBA allocation management information 1100 and updates the various data.

Specifically, for example, in a case where the write is to a segment (NVM module LBA) to which not even one NVM module PBA is associated, only the write-target NVM module PBA capacity acquired in S1502 becomes the change capacity of the NVM module PBA. Specifically, for example, the processor 215 adds the capacity of the NVM module PBA acquired in S1502 to the PBA allocation capacity 1101. Furthermore, for example, the processor 215 updates the remaining PBA allocation capacity 1102 to the value obtained by subtracting the capacity of the NVM module PBA acquired in S1502 from all the PBAs allocated to the segment.

Alternatively, when the write is to a segment (NVM module LBA) to which an NVM module PBA is already associated, the difference between the write-target NVM module PBA capacity acquired in S1502 and the NVM module PBA capacity invalidated by the write becomes the change capacity. Specifically, for example, from among the multiple NVM module PBA areas associated with the NVM module LBA area specified by the storage apparatus 101 in S1501, the difference between the NVM module PBA capacity for which the association with the NVM module PBA by the data update and the NVM module PBA capacity for writing new data acquired in the S1502 becomes the change capacity. The processor 215 adds the above-mentioned difference to the PBA allocation capacity 1101. The processor 215 also updates the remaining PBA allocation capacity 1102 to a value obtained by subtracting the above-mentioned difference from all the PBAs allocated to the segment.

In addition, the FM controller 210 adds the NVM module PBA capacity, for which the association with the NVM module LBA was cancelled by the data update, to the invalid PBA capacity 1103.

In S1505, the FM controller 210 notifies the storage controller 110 of the remaining PBA allocation capacity 1102, which changed in accordance with the NVM module PBA allocated in S1502 through S1504.

An example of a NVM module 126 write process has been explained hereinabove.

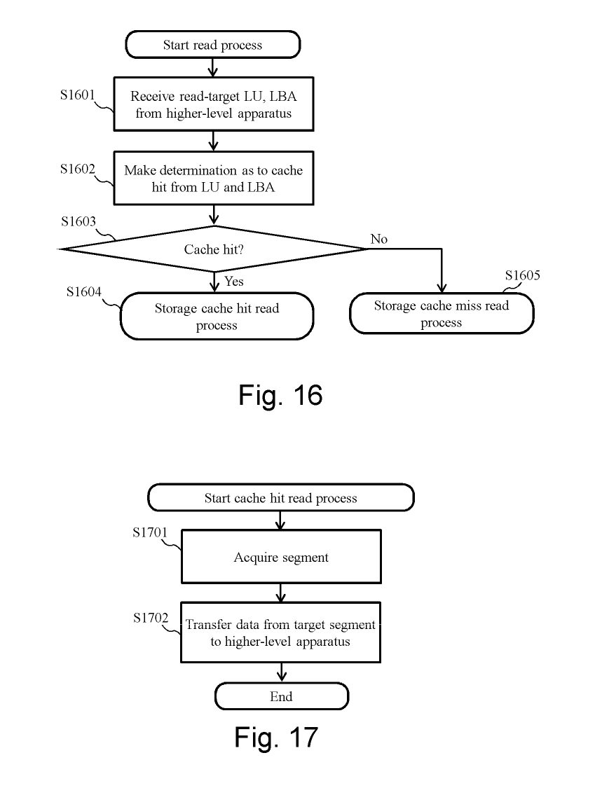

Next, a read process of the storage controller 110 related to the first example will be explained using FIGS. 16, 17 and 18.

FIG. 16 shows an example of a storage controller 110 read process related to the first example.

In S1601, the storage controller 110 receives an address (LU and LBA) specifying a read target from a server or other such higher-level apparatus 103.

In S1602, the storage controller 110 uses the LU and the LBA received from the higher-level apparatus 103 in S1601 to make a determination as to a cache hit. Specifically, for example, the processor 121 references the cache hit determination information 600 stored in the DRAM 125, and acquires the value in the cache segment number 605 identified in accordance with the LU and the LBA. In a case where the acquired value is a segment number, the processor 121 determines that there is a cache hit. Alternatively, in a case where the acquired value is not a segment number, the processor 121 determines that there is a cache miss.

In S1603, the storage controller 110 implements processing based on the result of the cache hit determination in S1602. In a case where the determination result in S1602 is a cache hit (S1603: Yes), the storage controller 110 performs a cache hit read process (S1604: refer to FIG. 17). Alternatively, in a case where the determination result in S1602 is cache miss (S1603: No), the storage controller 110 performs a cache miss read process (S1605: refer to FIG. 18).

First, the cache hit read process (S1604) will be explained using FIG. 17.

FIG. 17 shows an example of a cache hit read process of the storage controller 110 related to the first example.

The cache hit read process of the storage controller 110 is a process in which data stored in an area identified using the LU and the LBA received from the higher-level apparatus 103 is on a storage apparatus 101-managed cache, and is for reading the data on this cache.

In S1701, the storage controller 110 acquires detailed information on a segment to which a PBA has been allocated. Specifically, for example, the processor 121 references the cache segment management information 700 stored in the DRAM 125, and acquires the values of the DRAM/NVM module 702 and the DRAM/Address/NVM module LBA 703 of the row corresponding to the segment number acquired in S1602.

In S1702, the storage controller 110 reads the data from the segment, which is the target. In this example, there are two types of segments, i.e., a segment associated with the DRAM and a segment associated with the NVM module. In the case of a segment associated with the DRAM, the processor 121 sends data to the higher-level apparatus 103 from an identified area of the DRAM shown by the value of the DRAM/Address/NVM module PBA 703 acquired in S1701. Alternatively, in the case of a segment associated with the NVM module LBA, the processor 121 uses the value of the DRAM/NVM module 702 acquired in S1704 to read data from the NVM module 126 and to send the data to the higher-level apparatus 103.

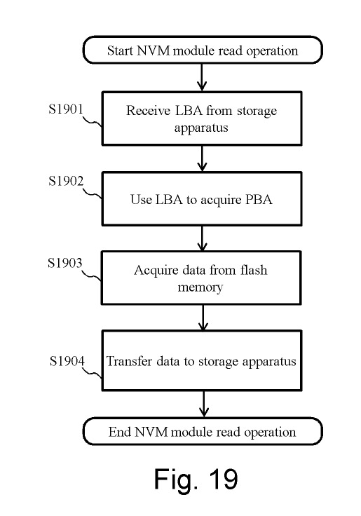

The NVM module 126, upon receiving the NVM module LBA from the storage controller 110, implements the read processing flow shown in FIG. 19. A detailed explanation of the NVM module read processing flow shown in FIG. 19 will be given further below.

An example of a cache hit read process of the storage controller 110 has been explained hereinabove. Next, a cache miss read process of the storage controller 110 in this example will be explained using FIG. 18.

FIG. 18 shows an example of a storage controller 110 cache miss read process related to the first example.

The cache miss read process is executed by the storage controller 110 in a case where the storage controller 110 has determined that there is a cache miss in S1603.

In S1801, the storage controller 110 acquires an LBA, which is in a RAID group configured from either multiple SSD 111 or HDD 112, and which will become the read destination of the read-target data. Specifically, for example, the processor 121 references the cache hit determination information 600 stored in the DRAM 125, and acquires the values of the RAID group 603 defined by the LU and the LBA, and an LBA in RAID group 604.

In S1802, the storage controller 110 acquires data based on the RAID group 603 and the LBA in RAID group 604 acquired in S1801. Specifically, for example, the processor 121 instructs the disk interface 123 to read the read-target data from the RAID group configured from either the SSD 111 or the HDD 112 and to send this data to either the DRAM 125 in the storage controller 110 or the RAM 213 in the NVM module 126.

In S1803, the storage controller 110 sends the read-target data acquired in S1802 to the higher-level apparatus 103. Specifically, for example, the processor 121 instructs the host interface 124 to send the read-target data, which was stored in either the DRAM 125 in the storage controller 110 or the RAM 213 in the NVM module 126 in S1802, to the higher-level apparatus 103.

In S1804, the storage controller 110 either acquires or calculates the remaining PBA allocation capacity. Specifically, for example, the processor 121 acquires the PBA allocation management information 1100 from the NVM module 126, and acquires the value of the remaining PBA allocation capacity 1102 from therewithin. Or, the processor 121 calculates the sum total of the NVM module PBA allocation capacity 706 in the cache segment management information 700 as the number of NVM module PBA allocations, subtracts this value from the total NVM module PBA allocation capacity of the NVM module, and calculates the remaining PBA allocation capacity.

In S1805, the storage controller 110 judges whether or not the remaining NVM module PBA allocation capacity, which was either acquired or calculated in S1804, is larger than a predetermined threshold. In a case where the remaining PBA allocation capacity either acquired or calculated in S1804 is larger than the predetermined threshold, the storage controller 110 performs the processing of S1806, which acquires a segment having the free attribute, in order to increase the segments to be used. Alternatively, in a case where the remaining NVM module PBA allocation capacity either acquired or calculated in S1804 is equal to or less than the predetermined threshold, the storage controller 110 performs the processing of S1811, which acquires a clean-attribute segment in order to update and use new data in the clean-attribute segments already being used without changing the number of segments to be used.

In S1806 (S1805: Yes), the storage controller 110 acquires a free-attribute segment. The storage controller 110 selects a free-attribute segment, which has not been used, as the segment for caching the read data acquired from the RAID group 603 in S1802.

In S1811 (S1805: No), the storage controller 110 acquires a clean-attribute segment. The storage controller 110 selects, from among a group of clean-attribute segments in use, a segment for caching the read data acquired from the RAID group 603 in S1802 in accordance with a prescribed rule (for example, a segment for which the longest time period has elapsed since being accessed using LRU management).

In S1812, in a case where the segment acquired in S1811 is associated with a NVM module LBA, the storage controller 110 notifies the NVM module 126 to release the NVM module PBA associated with this NVM module LBA. The NVM module 126 (FM controller 210), upon receiving this notification, references the LBA-PBA translation table 900, and erases the value in the corresponding NVM module PBA 902. The FM controller 210 also updates the value in the PBA allocation capacity 1101 of the PBA allocation management information 1100 by subtracting the capacity of the NVM module PBA for which the association with the NVM module LBA was cancelled. Next, the FM controller 210 adds the capacity of the NVM module PBA for which the association with the NVM module LBA was cancelled to the value in the remaining PBA allocation capacity 1102. In addition, the FM controller 210 adds the capacity of the NVM module PBA for which the association with the NVM module LBA was cancelled to the value in the invalid PBA capacity 1103.

In S1807, the storage controller 110 writes the data to the write-target segment acquired in either S1806 or S1811.

As described hereinabove, in this example, there are two types of segments, i.e., a segment associated with the DRAM and a segment associated with the NVM module. In the case of a segment associated with the DRAM, the processor 121 writes the data received from the higher-level apparatus 103 to an identified area of the DRAM shown by the value in the DRAM Address/NVM module LBA 703 acquired in either S1304 or S1309. Alternatively, in the case of a segment associated with the NVM module LBA, the processor 121 sends the write data received from the higher-level apparatus 103 to the NVM module 126 together with the value of the NVM module LBA acquired in either S1304 or S1309. The NVM module 126, upon receiving the write data and the NVM module LBA from the storage controller 110, implements the write process shown in FIG. 15.

In S1808, the storage controller 110 updates the management information for managing the association between the segment to which the data was written in S1807 and the LU and the LBA received from the higher-level apparatus 103 in S1601. Specifically, for example, the processor 121 references the cache hit determination information 600 stored in the DRAM 125, and updates the cache segment number 605 identified in accordance with the LU and the LBA acquired in S1601 to the segment number of the segment acquired in either S1806 or S1811. According to this process, the newly allocated segment is associated with the read-target LU and LBA.

In S1809, the storage controller 110 either acquires or calculates the remaining PBA allocation capacity. This step is implemented by the storage controller 110 only when data has been written to the segment associated with the NVM module LBA in S1807, and is not implemented when the data is written to a segment associated with the DRAM.

In S1810, the storage controller 110 determines whether or not the new remaining PBA allocation capacity, which was either acquired or calculated in S1809, is larger than a predetermined threshold. In a case where the remaining PBA allocation capacity is larger than the predetermined threshold, the storage controller 110 write process ends since the NVM module PBA allocation capacity has room to spare and a segment release process is not necessary. Alternatively, when the remaining NVM module PBA allocation capacity is equal to or less than the threshold, the NVM module PBA allocation capacity is starting to run out, and as such, the storage controller 110 implements a segment release process.

The cache miss read process of the storage apparatus 101 has been explained hereinabove.

Next, a NVM module 126 read process of the first example will be explained using FIG. 19.

FIG. 19 shows an example of a NVM module 126 read process of the first example. In S1901, which is the first step of the NVM module 126 read process, the NVM module 126 (FM controller 210) receives a NVM module LBA from the storage controller 110 as a read-destination address.

In S1902, the FM controller 210 acquires a PBA to serve as a read target. Specifically, for example, the processor 215 references the LBA-PBA translation table 900 and acquires the value in the NVM module PBA 902 associated with the NVM module LBA 901 acquired in S1901 as the read target.

In S1903, the FM controller 210 reads data from the flash memory shown by the NVM module PBA acquired as the read target in S1902. The data read at this time is stored in the data buffer 216.

In S1904, the FM controller 210 sends the data, which was stored in the data buffer 216 in S1903, to the storage controller 110.

In accordance with the above, the NVM module 126 read process ends.

According to the first example, the NVM module 126 can use the LBA-PBA translation table 900, which is provided in the NVM module 126, to allocate an NVM module PBA 902 that matches a data size stored in a segment. The NVM module 126 can also increase the number of segments in use when there is an unallocated NVM module PBA 902, and can reduce the number of segments in use when the unallocated NVM modules PBA 902 have run out.

In accordance with making possible cache control like that described above, in this example, a physical storage area (physical page) inside the NVM module 126 can be used efficiently even when the cache management unit (the size of the segment) has been enlarged for the purpose of lessening the load on the processor 121.

In accordance with enabling cache control like that described above, in this example, it is possible to make efficient use of a physical storage area (physical page) inside the NVM module 126 and to enhance the probability of a cache hit even when the cache management unit (the size of the segment) has been enlarged for the purpose of lessening the load on the processor 121. Furthermore, in a case where a physical capacity has been virtualized in a storage medium in which data is ultimately to be stored (hereinafter, final storage medium), a large amount of management information and control is required anew to manage a change in the size of the usable logical area, but in this example, since the capacity virtualization target is the cache, the change in the size of the usable logical area can be absorbed by expanding ordinary cache control. That is, existing management information may simply be expanded on the storage apparatus 101 side without the need for new control information for managing the capacity change. In addition, since the capacity virtualization target is the cache, there is no need to reserve a fixed physical storage area as in a case where the capacity of the final storage medium is virtualized. Therefore, the cache control of this example makes it possible to effectively utilize a change in the size of the usable logical area by performing control so as to either migrate data from the cache to another storage apparatus or to migrate data from another storage apparatus to the cache in accordance with the change in the size of the usable logical area.

### Example 2

A second example will be explained next.

In the first example, an example of cache control was described in which, when writing data to the NVM module 126, the processor 215 allocates a NVM module PBA only to an area where data exists within the NVM module LBA area, and associates an unallocated NVM module PBA to a virtually expanded NVM module LBA.

In addition to the cache control of the first example, the second example performs reversible compression (hereinafter shown simply as compression) on data inside the NVM module 126 to further reduce the NVM module PBA to be allocated to the NVM module LBA.

In accordance with further reducing the NVM module PBA allocated to the NVM module LBA by compressing the data, in the second example, it is possible to expand the area of the NVM module LBA more than in the first example, enabling more efficient use of the physical storage area of the NVM module 126.

The configuration of the storage apparatus 101 and the management information of the second example are substantially the same as those of the first example, and as such, explanations thereof will be omitted. The processing of the storage apparatus 101 in the second example will be explained by focusing on the points of difference with the first example.

In the first example, since the NVM module PBA allocation capacity is already known when the storage controller 110 sends data to the NVM module 126, it is possible to store the value in the NVM module PBA allocation capacity 706 of the cache segment management information 700 without acquiring the NVM module PBA allocation capacity from the NVM module 126.

However, in the second example, since the NVM module 126 compresses the data, the allocation capacity of the NVM module PBA will change depending on the data compression ratio. Thus, the storage controller 110 must acquire the NVM module PBA allocation capacity from the NVM module 126 on a regular basis (preferably consecutively).

In accordance with this, the storage controller 110 can acquire the NVM module PBA allocation capacity from the NVM module 126 when a difference occurs between the amount of data managed by the storage controller 110 and the NVM module PBA capacity, which has been changed by the data compression inside the NVM module 126. Thus, the storage controller 110 is able to manage the exact NVM module PBA allocation capacity as well as the remaining NVM module PBA allocation capacity.

In a case where the storage controller 110 is able to accurately manage the NVM module PBA allocation capacity, the processing of the storage controller 110 is substantially the same as that of the first example. In the second example, it becomes possible for the NVM module 126 to control the cache by making use of the compression function.

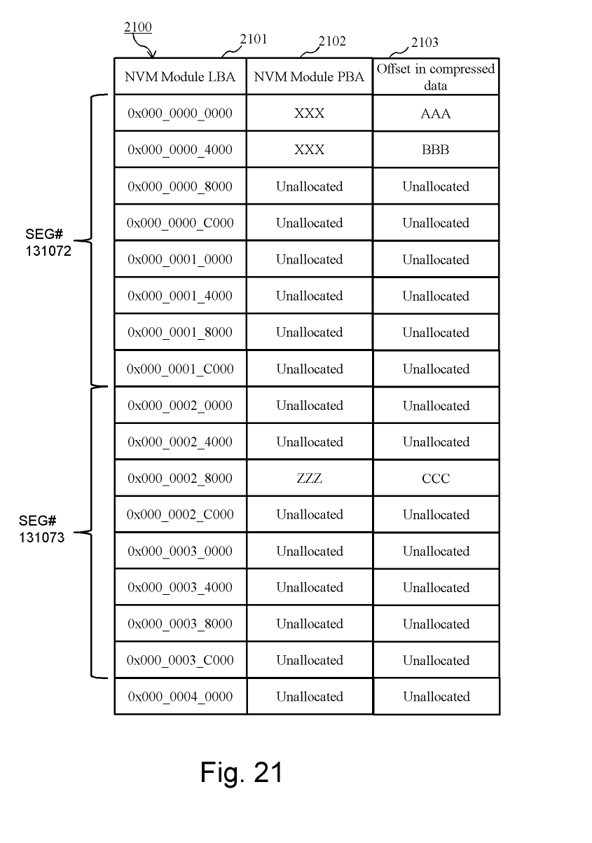

Next, a LBA-PBA translation table 2100 used by the NVM module 126 of the second example will be explained using FIG. 21.

FIG. 21 shows a LBA-PBA translation table 2100 of the second example.

The LBA-PBA translation table 2100 is stored in the RAM 213 of the NVM module 126, and comprises a NVM module LBA 2101, a NVM module PBA 2102, and an offset within compressed data 2103. The NVM module 126 processor 215, upon receiving a NVM module LBA based on a read/write command from the higher-level apparatus 103, uses this NVM module LBA to acquire the NVM module PBA, which shows the area in which the actual data is stored as the compressed data, and an offset within the data, which decompresses the compressed data. In this example, the LBA-PBA translation table 2100 is used the same as in the first example to make efficient use of the physical storage area of the NVM module 126 in accordance with associating a NVM module PBA only with a NVM module LBA in which data exists.

The NVM module LBA 2101 is the same as that of the first example, and as such an explanation will be omitted.

The NVM module PBA 2102 stores information showing an area for identifying all the FM chips (220 through 228) managed by the NVM module 126. In this example, the NVM module PBA 2102 has an address, which has been segmented into a page unit, which is the smallest write unit of the FM chips (220 through 228). In the example of FIG. 9, a PBA named “XXX” is associated as the PBA (Physical Block Address) associated with the NVM module LBA “0x000_{—}0000_{—}0000”. This PBA is an LBA-based address for uniquely showing the storage area of the FM chip (220 through 228) storing data, which is data that has been compressed (hereinafter, compressed data). In accordance with this, in a case where the NVM module LBA “0x000_{—}0000_{—}0000” has been received as a read command reference-destination address, the physical read destination storing the compressed data in the NVM module 126 is acquired.

The offset within compressed data 2103 shows the start address of an area, which, when the compressed data stored in an area specified by the NVM module PBA 2102 has been decompressed, is associated with the NVM module LBA within this decompressed data (hereinafter, decompressed data).

The storage controller 110, after acquiring the data from the area shown by the NVM module PBA at read processing time and subjecting this data to decompression processing, sends the decompressed data and the offset within compressed data 2103 with this decompressed data to the higher-level apparatus 103. In this example, an example in which the offset within compressed data 2103 is stored in the LBA-PBA translation table 2100 of the storage apparatus 101 is presented, but this example is not limited to this example.

For example, the offset within compressed data 2103 may be stored in a fixed-length area at the head of the compressed data. In accordance with this, the LBA-PBA translation table 2100 becomes the same as that of the first example. In a case where an offset within the compressed data is stored inside the compressed data, the storage apparatus 101 acquires the LBA included in the decompressed data and the association information of the offset within the compressed data after the compressed data of the area shown by the NVM module PBA has been decompressed.

The LBA-PBA translation table 2100 of the second example has been explained hereinabove.

Because the second example differs from the first example and the NVM module 126 compresses data and stores this compressed data in the FM chips, the storage controller 110 is not able to infer the NVM module PBA allocation capacity 706 from the amount of data sent to the NVM module 126. In this regard, the storage controller 110 acquires the NVM module PBA allocation capacity of each segment from the NVM module 126, and performs management based on the acquired PBA allocation capacity the same as in the first example.

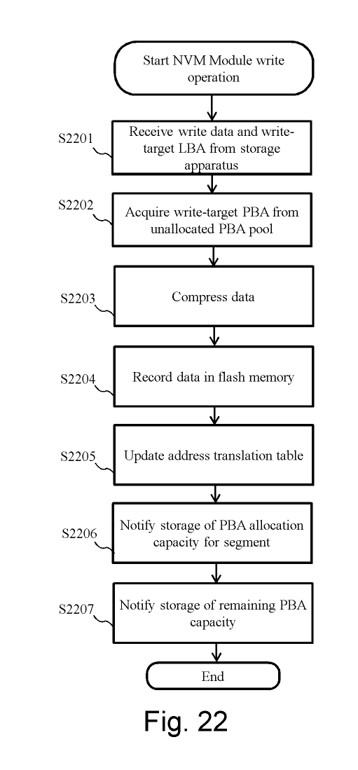

Next, a NVM module write process of this example will be explained using FIG. 22.

FIG. 22 shows an example of a NVM module 126 write process related to the second example. In comparison to the write process of the first example (refer to FIG. 15), this write process adds a process (S2203) for compressing the write data and a process (S2207) for notifying the storage apparatus 101 of the NVM module PBA capacity.

Since S2201 is substantially the same as S1501 of the first example, an explanation will be omitted. S2202, which follows, is also substantially the same as S1502 of the first example, and as such, an explanation will be omitted.

In S2203, which follows S2102, the write data is compressed. Specifically, for example, the processor 215 instructs the data compressor 218 to compress the data. Then, the data compressor 218, which received the instruction, compresses the write data, which was received from the storage apparatus 101 in S2201 and is stored in the data buffer 216, and stores the compressed data in another area of the data buffer 216.

In S2204, which follows S2203, the FM controller 210 writes the write data, which was compressed in S2203, to the area shown by the NVM module PBA acquired in S2202. Specifically, for example, the processor 215 sends the write destination of the compressed write data created in S2203 and the NVM module PBA acquired in S2202 to the FM interface 217, and instructs the FM interface 217 to write this information to the FM chips (220 through 228). Then, the FM interface 217, which received the indication, reads the write data compressed in S2203 from the data buffer 216, sends the write data to the FM chips (220 through 228) shown by the NVM module PBA, and writes the data to the NVM module PBA-specified storage area in the FM chips (220 through 228).

In S2205, the FM controller 210 associates the NVM module PBA showing the write destination of the compressed write data acquired in S2202 and the offset within the compressed data with the LBA acquired in S2201. Specifically, for example, the processor 215 references the LBA-PBA translation table 2100 stored in the RAM 213, and updates to NV module PBA 2102 of the LBA acquired from the storage apparatus 101 in S2201 to the NVM module PBA acquired as the write destination of the compressed data in S2102. In addition, the processor 215 updates the offset within compressed data 2103 corresponding to the LBA acquired in S2201 to the offset within the data compressed in S2203.

In S2206 the FM controller 210 notifies the storage controller 110 of the capacity of the NVM module PBA allocated by the NVM module 126 in units of segments to which the LBA acquired from the higher-level apparatus 103 in S2201 are allocated.

The NVM module 126 of the second example is aware of the corresponding relationship between a storage controller 110-managed segment and a NVM module LBA, and is able to notify the storage controller 110 of the associated NVM module PBA capacity for each segment to which the NVM module LBA acquired in S2201 is allocated.

The storage controller 110, in accordance with acquiring the NVM module PBA allocation capacity of each segment from the NVM module 126, for example, can implement at an appropriate time a segment release process, which is executed when the NVM module PBA have run out. Specifically, for example, the storage controller 110 can acquire the exact NVM module PBA capacity, which reflects the compression ratio of the compressed data, when acquiring the NVM module PBA capacity released in accordance with the release of the release-target segment in S1404. Thus, the storage controller 110 can implement a segment release process at an appropriate time.

In S2207, the FM controller 210 notifies the storage controller 110 of the remaining PBA allocation capacity 1102 for each segment.

An example of the NVM module 126 write process has been explained hereinabove.

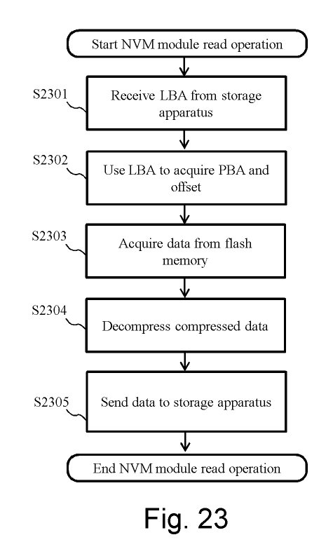

Next, a NVM module 126 read process of this example will be explained using FIG. 23.

FIG. 23 shows an example of a NVM module 126 read process related to the second example. In comparison to the read process of the first example (refer to FIG. 19), the read process of the second example adds a compressed data decompression step (S2304).

In S2301, the FM controller 210 acquires from the storage controller 110 an NVM module LBA, which will become the read target.

In S2302, the FM controller 210 acquires the NVM module PBA and the offset within the compressed data, which are associated with the NVM module LBA acquired in S2301. Specifically, for example, the processor 215 references the LBA-PBA translation table 2100 stored in the RAM 213, and acquires the NVM module PBA 2102 and the offset within compressed data 2103 of the NVM module LBA acquired in S2301.

In S2303, the FM controller 210 uses the NVM module PBA acquired in S2302 to acquire the compressed data from the FM chips (220 through 228). Specifically, for example, the processor 215 notifies the FM interface 217 of the NVM module PBA, and instructs the FM interface 217 to read the data. Then, the FM interface 217, which received the indication, reads the data of the area shown by the NVM module PBA from the FM chips (220 through 228) specified by the NVM module PBA. In addition, the FM interface 217 sends the compressed data read from the FM chips (220 through 228) to the data buffer 216.

In S2305, the FM controller 210 decompresses the compressed data acquired in S2303. Specifically, for example, the processor 215 notifies the data compressor 218 of the area of the data buffer 216 storing the compressed data, and instructs the data compressor 218 to decompress the compressed data. The data compressor 218, upon receiving the indication, reads the compressed data from the instructed data buffer 216 area, and decompresses the compressed data, which has been read. The data compressor 218 also stores the decompressed data in the data buffer 216.

In S2306, the FM controller 210 uses the offset within compressed data 2103 acquired in S2302 to send the storage controller 110 only the data associated with the requested NVM module LBA from among the decompressed data. Specifically, for example, the processor 215 instructs the I/O interface 211 to send only the specified area of the offset within compressed data 2103 from the decompressed data stored in the data buffer 216. The I/0 interface 211, upon receiving the indication, sends the storage controller 110 the data inside the area specified by the offset within compressed data 2103 from among the decompressed data.

An example of the NVM module 126 read process has been explained hereinabove.

As explained hereinabove, in the second example, the NVM module 126 is able to reduce the amount of data stored in the NVM module PBA area by making good use of the function for compressing/decompressing the data. As a result of this, it is possible to reduce the NVM module PBA capacity associated with the NVM module LBA, enabling the virtual storage area of the NVM module LBA to be expanded more than in the first example. Since the storage apparatus 101 can also increase the number of segments to be used, the physical storage area of the NVM module can also be used more effectively than in the first example.

In the second example, the storage apparatus 101 can be notified of the NVM module PBA allocation capacity, which changes in accordance with the data compression ratio, thereby making it possible to implement at the appropriate time a segment release process, which is executed when the PBAs have run out.

### Example 3

A third example will be explained next.

Since the configuration and management information of a NVM module 126 of the third example are substantially the same as in the first example, explanations will be omitted.

The NVM module 126, as was described hereinabove, performs a reclamation for the purpose of erasing the data inside an invalid PBA area in units of blocks and of reserving an unwritten PBA area in units of blocks when the invalid PBA capacity becomes equal to or larger than a prescribed threshold.

Because valid data must be copied to another area in this reclamation, the less valid data included in the erase-target physical block the better. Thus, the NVM module 126 of the first and second example searches for a block having few valid PBA areas. However, in the first and second examples, a process for searching for a block having few valid PBA areas (a PBA associated with a LBA) must be performed at the time of a reclamation.

To improve the efficiency of a reclamation using this method, the threshold, which constitutes the trigger for the reclamation, must be increased. When increasing this threshold, the percentage of invalid PBA capacity included in the NVM module 126 storage area as a whole increases. Thus, the invalid PBA capacity included in the erase area at reclamation stochastically increases and the valid PBA capacity included in the erase area at reclamation stochastically decreases. That is, since the number of blocks having few valid PBA areas increases in accordance with increasing the threshold in the first and second examples, it is possible to lessen the processing time for searching for a block having few valid PBA areas. This makes it possible to improve reclamation efficiency.

However, the drawback of the process for increasing the threshold like this is that it increases costs. This is because it is necessary to increase the spare area (area for saving a fixed amount of the invalid PBA capacity) corresponding to the increase in the invalid PBA capacity when increasing the percentage of the invalid PBA capacity included in the NVM module 126 storage area as a whole. For example, in the case of a NVM module 126 that provides the storage apparatus 101 with a 100-GB storage area, a physical storage area of at least approximately 111 GB is necessary to configure a threshold that allows 10% of the area to be invalid PBA capacity. Alternatively, a physical storage area of at least approximately 142 GB is necessary to increase the threshold so as to allow 30% of the area to be invalid PBA capacity. Thus, a physical spare area for saving the invalid PBA area is needed to increase the threshold, and the spare area raises costs.

In the third example, a method for reducing the valid PBA capacity to be copied at reclamation time without increasing the spare area will be explained.

In the third example, the storage controller 110 notifies the NVM module 126 of a low-priority segment. Then, the NVM module 126 (FM controller 210) manages an area associated with the low-priority segment as an “erasable but accessible area”. Then, at the time of a reclamation, the NVM module 126 treats the “erasable but accessible area” as an area that can be erased the same as the invalid PBA area.

By treating the low-priority segment the same as the invalid PBA area at the time of a reclamation, the same effect as was described hereinabove is achieved, i.e., the percentage of invalid PBA capacity included in the NVM module 126 storage area as a whole is increased.

Specifically, for example, in the third example, the storage controller 110 does not notify the NVM module 126 of an indication to perform releases in order from a segment selected in accordance with a prescribed rule as in the first example, but rather only notifies the NVM module 126 of the segment selected in accordance with the prescribed rule and does not instruct the NVM module 126 to perform a release.

Here, the segment selected in accordance with a prescribed rule, for example, is either a segment for which the longest time has elapsed since being accessed or a segment having a relatively low access frequency. Hereinafter, segments selected by the storage apparatus 101 based on a prescribed rule will be regarded as a segment group.

The NVM module 126, which has been notified of the segment group by the storage controller 110, selects from this area an area for which a reclamation can be performed efficiently (an area having little copy data), and the NVM module 126 decides on the segment to be released.

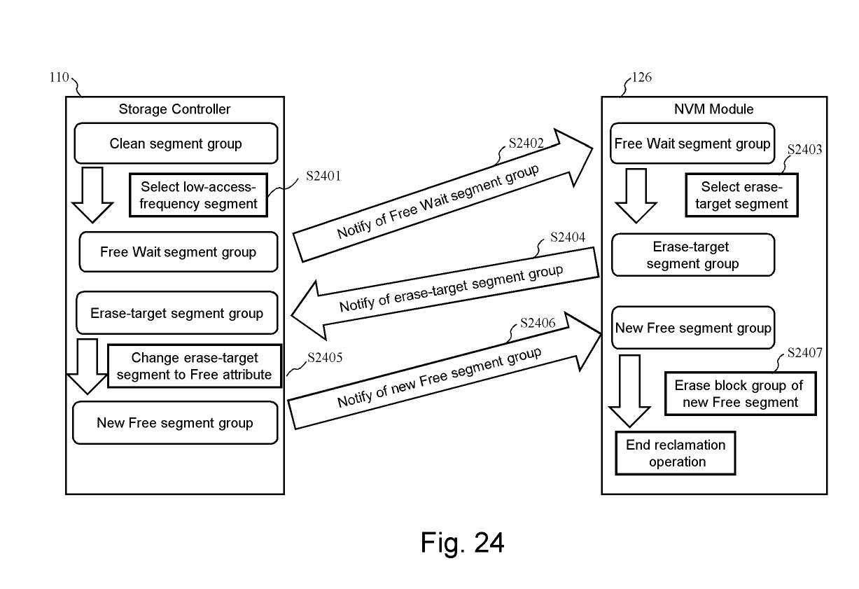

FIG. 24 is a conceptual drawing showing an outline of the reclamation process of the third example.

The storage controller 110 (processor 121), for example, “selects a segment having a relatively low access frequency” from the clean-attribute segments, and changes the attribute of the selected segment from clean to free wait (S2401). The “segment having a relatively low access frequency” referred to here may be one or more segments having an access frequency that belongs to the lower X % from among the clean-attribute segment group (where X is a numerical value larger than 0). The processor 121 creates multiple free wait-attribute segments. Hereinafter, these multiple free wait-attribute segments will be regarded as a “free wait segment group”. A free wait-attribute segment describes a segment, among the clean-attribute segments, which the storage apparatus 101 has judged may serve as a free-attribute segment.

Next, the storage apparatus 101 notifies the NVM module 126 of the free wait segment group (S2402).

The NVM module 126 (FM controller 210) “selects a segment to be an erase target” from the notified free wait segment group (S2403). As the rule for this “select a segment to be an erase target”, in the third example, the selection of a free wait segment erase candidate is performed so as to decrease the valid PBA areas included in the erase-target area.

Next, the FM controller 210 notifies the storage controller 110 of an erase-target segment group (S2404).

The storage controller 110 changes the management information of the segments corresponding to the NVM module 126-notified erase-target segment group from “free wait” to “free” (S2405). As a result of this, a new free segment group is created. According to this processing by the storage controller 110, a segment for which the attribute has been changed to free is no longer accessible from a server or other such higher-level apparatus 103.

The storage controller 110 notifies the NVM module 126 of information (new free segment group information) for identifying a new free segment group, which is a group of segments that may be erased from the erase-target segment group that has received a notification from then NVM module(S2406).

The NVM module 126 (FM controller 210), in accordance with receiving the new free segment group information from the storage controller 110, acquires permission from the storage controller 110 to erase the data in the segment. The FM controller 210 erases the data in the new free segment group (specifically, the data in the physical block allocated to the new free segment).

The preceding is an outline of the reclamation process in accordance with this example. Furthermore, S2401 and S2402 are implemented when the remaining PBA allocation capacity described in the first example falls below the threshold for reducing the segments to be used. Alternatively, S2403 through S2407 are implemented when the threshold for the invalid PBA capacity 1103 in the PBA allocation management information 1100 managed by the NVM module 126 is exceeded.

In this example, the NVM module 126 notifies the storage controller 110 of the erase-target segment, and after acquiring erase permission from the storage controller 110, erases the data in the segment for which permission was granted. However, this example is not limited thereto. For example, the processing of S2404 through S2406 may be eliminated, and the data in the erase-target segment (the data in the physical block allocated to the erase-target segment) may be erased immediately after S2403. In accordance with this, the storage controller 110, upon issuing a read/write command to the erased segment, receives a response from the NVM module 126 that the segment has already been erased. In accordance with this response, the storage controller 110 changes the attribute of the segment from “free wait” to “free”. In accordance with this process, the NVM module 126, for example, can stop sending nonexistent data (or invalid data) to the storage controller 110 (S2407).

The configuration and management information of the storage apparatus 101 of the third example are the same as those of the first example, and as such, explanations will be omitted. The processing of the storage apparatus 101 in the third example will be explained by focusing on the points of difference with that of the first example.

The configuration of the NVM module 126 of the third example is the same as that of the first example, and as such, an explanation will be omitted.

The management information of the NVM module 126 will be explained. The LBA-PBA translation table, which is management information of the NVM module 126 of the third example, is substantially the same as that of the first example, and as such, an explanation will be omitted.

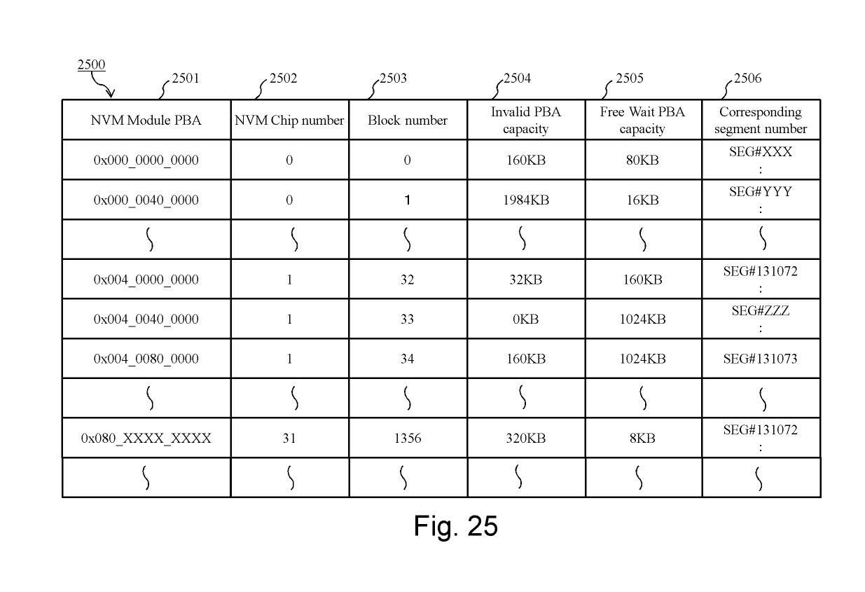

Block management information 2500 used by the NVM module 126 of the third example will be explained using FIG. 25.

FIG. 25 shows the block management information 2500 related to the third example.

The block management information 2500 is stored in the RAM 213 inside the NVM module 126. The block management information 2500 comprises, for each NVM module PBA (physical block), a NVM module PBA 2501, a NVM chip number 2502, a block number 2503, an invalid PBA capacity 2504, a free wait PBA capacity 2505, and a corresponding segment number 2506.

Of the items mentioned above, the NVM module PBA 2501, the NVM chip number 2502, the block number 2503, and the invalid PBA capacity 2504 are substantially the same as the first example, and as such, explanations will be omitted.

The free wait PBA capacity 2505 shows the total capacity of a valid page in a physical block allocated to a free wait segment. The valid data in the physical block allocated to the free wait segment is clean data stored in the storage device. Thus, the valid data in the physical block allocated to the free wait segment is data, which may be erased without being copied to another physical block.

The storage controller 110 of this example, upon changing the attribute of the segment to free wait, notifies the NVM module 126 of this segment and of the NVM module LBA of this segment. In the NVM module 126, which receives the notification, the processor 215 references the block management information 2500, and adds the PBA capacity, which had been registered as free wait, to the corresponding free wait PBA capacity 2505. In this example, for example, the processor 215 calculates the total value of the free wait PBA capacity and the invalid PBA capacity 1004 for each block, and treats a block having a large total value as an erase-target block in the reclamation process.

In the reclamation process, valid data, which must be copied from the erase-target block to another block, is data that is stored in an area other than the free wait PBA and the invalid PBA. Thus, the selection as an erase target of a block for which the total value of the free wait PBA capacity and the invalid PBA capacity 1004 is relatively large makes it possible to select a block having a small amount of valid data to be copied at the time of the reclamation.

The corresponding segment number 2506 is the number of a segment to which belongs the logical block, which is the allocation destination of the physical block.

The NVM module 126 of this example, upon storing data received from the storage controller 110, allocates a NVM module PBA to the NVM module LBA specified by the storage controller 110. At this time, the processor 215 of the NVM module 126 acquires the segment number related to the NVM module LBA associated with the NVM module PBA. Then, the processor 215 references the block management information 2500, and adds the acquired segment number to the corresponding segment number 2506, which corresponds to the NVM module PBA. When the corresponding block is erased, the corresponding segment number 2506 is also erased.

According to the information of this corresponding segment number 2506, the NVM module 126 of this example can acquire the segment number associated with a block, which has been selected as an erase target, and can notify the storage controller 110 of the erase-target segment at the time of the reclamation process.

The block management information 2500 used by the NVM module 126 has been explained hereinabove.

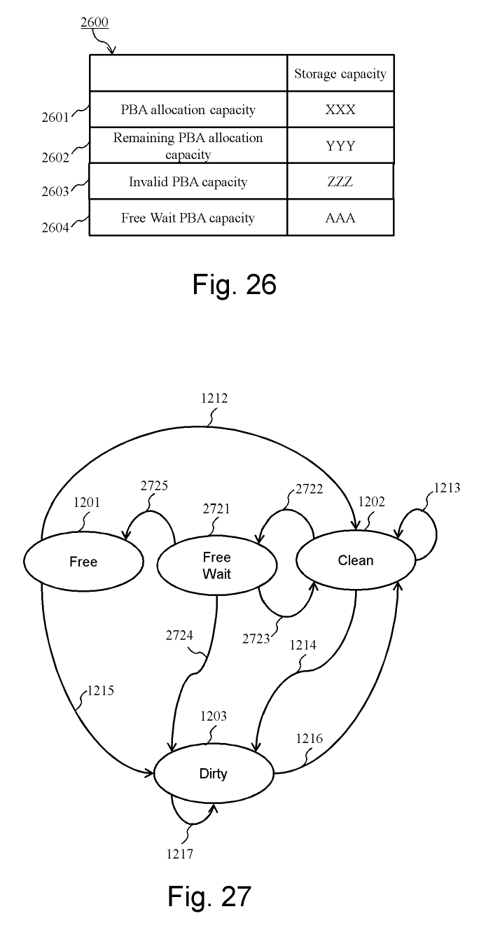

Next, PBA allocation management information 2600 used by the NVM module 126 to which this example is applied will be explained using FIG. 26.

FIG. 26 shows the PBA allocation management information 2600 related to the third example.

The PBA allocation management information 2600 is stored in the NVM module 126 (for example, the RAM 213).

The PBA allocation management information 2600 comprises a PBA allocation capacity 2601, a remaining PBA allocation capacity 2602, an invalid PBA capacity 2603, a free wait PBA capacity 2604, and a storage capacity 2605. Of these, the PBA allocation capacity 2601, the remaining PBA allocation capacity 2602, and the invalid PBA capacity 2603 are substantially the same as in the first example, and as such, explanations will be omitted.

The free wait PBA capacity 2604 shows the total capacity of the PBA constituting free wait from among the NVM module 126-managed PBAs.

The NVM module 126 implements a reclamation in a case where the total value of the value of the invalid PBA capacity 2603 and the free wait PBA capacity 2604 has become equal to or larger than a reclamation start threshold, and makes the total value of the invalid PBA capacity and the free wait PBA capacity equal to or less than a fixed value.

In this example, the NVM module 126 notifies the storage controller 110 of the PBA allocation management information 2600 in a case where the PBA allocation management information 2600 has been updated.

The PBA allocation management information 2600 has been explained hereinabove.

The NVM module 126 of this example uses the LBA-PBA translation table 900, the block management information 2500, and the PBA allocation management information 2600 described heretofore to control the cache storage area.

FIG. 27 is a conceptual drawing describing the transitions of segment attributes in the cache control related to the third example. Here, the explanation will focus on the points of difference of the various attribute transitions of the third example with respect to the first example.

˜Segment Attribute Transition 2722 From Clean to Free Wait˜

The transition 2722 of the segment attribute from clean to free wait is implemented when the remaining allocation capacity of the NVM module PBA falls below a threshold, that is, when there arises a need to decrease the number of segments to be used. The number of remaining allocations of the NVM module PBA, which is used as the criterion for this judgment, may also be the value of the remaining PBA allocation capacity 2602 of the PBA allocation management information 2600 managed by the NVM module 126, and may be determined by calculating the sum total of the NVM module PBA allocation capacity 706 of the cache segment management information 700 managed by the storage controller 110 as the number of NVM module PBA allocations, and subtracting the calculated number from the entire allocation capacity of the NVM module PBA.

When the remaining NVM module PBA allocation capacity falls below the threshold for reducing the segments to be used, the storage controller 110, based on a prescribed rule, selects from among the clean-attribute segments a segment to be used as a free wait.

At this time, the storage controller 110 uses the number of the selected segment from the cache segment management information 700 to acquire the NVM module PBA allocation capacity 706 of the segment regarded as a free wait.

The NVM module 126 adds this value to the remaining PBA allocation capacity 2602. In a case where the result of the addition is that the remaining PBA allocation capacity 2602 exceeds the threshold, the free wait creation process ends.

Alternatively, in a case where the remaining PBA allocation capacity 2602 is equal to or less than the threshold, the storage controller 110 configures an additional segment to free wait. In this way, the storage controller 110 continues to change a clean-attribute segment to a free wait attribute and to increase the free wait-attribute segments until the remaining PBA allocation capacity 2602 exceeds the prescribed threshold.

The transition 2722 of the segment attribute from clean to free wait may be forcibly implemented when the segment access frequency has become equal to or less than a certain criterion even in a case where remaining PBA allocation capacity 2602 is not equal to or less than the prescribed threshold.

˜Segment Attribute Transition 2723 From Free Wait to Clean˜

The transition 2723 of the segment attribute from free wait to clean is implemented in a case where there is a read access to a free wait-attribute segment, and, in addition, data related to the read access is stored in the NVM module PBA associated with the free wait-attribute segment. In accordance with the transition of the attribute of the segment to the clean attribute, another segment having a low access frequency can be transitioned from clean to free wait when the remaining PBA allocation capacity 2602 falls below a prescribed threshold.

˜Segment Attribute Transition 2724 From Free Wait to Dirty˜

The transition 2724 of the segment attribute from free wait to dirty is implemented in a case where there has been a write access to the free wait-attribute segment, that is, a case in which there was a data update request with respect to the free wait-attribute segment. In accordance with the transition of the segment attribute to the dirty attribute, another segment having a low access frequency can be transitioned from clean to free wait when the remaining PBA allocation capacity 2602 falls below a prescribed threshold.

˜Segment Attribute Transition 2725 From Free Wait to Free˜

The transition 2725 of the segment attribute from free wait to free is implemented by the storage apparatus 101 when a “notification of an erase-target segment group” has been issued from the NVM module 126. The NVM module 126 changes the attribute of the segment scheduled to be erased from free wait to free.

The storage controller 110, triggered by the transition 2725 of the segment attribute from free wait to free, references the cache hit determination information 600 stored in the DRAM 125 and changes the value of the cache segment number 605 corresponding to the segment, which has been made free, to “none”.

Segment attribute transitions have been explained hereinabove. This example is not limited to only the four types of segment attributes of clean, free wait, free, and dirty. This example is effective even in a case where there are four or more types of segment attributes including clean, free wait, free, and dirty.

As explained hereinabove, in the third example, the storage apparatus 101 notifies the NVM module 126 of a segment, which has a low access frequency, as a free wait-attribute segment. Then, the NVM module 126 treats the NVM module PBA area associated with the free wait-attribute segment as an erasable area similar to the invalid PBA area only at the time of a reclamation process.

According to this process, the amount of valid PBA area copying generated at the time of a reclamation can be reduced, making possible an efficient reclamation process. According to the efficient reclamation process, the performance of the NVM module 126 is enhanced and the amount of writing to the FM chips (220 through 228) as a result of a copy is reduced, thereby decreasing the deterioration of the FM chips (220 through 228) in line with a write and prolonging the life of the NVM module 126. These effects are added in addition to the effects shown in accordance with the first example.

### Example 4

A fourth example will be explained next.

It is a known fact that the degree of deterioration of a NAND-type flash memory or other such nonvolatile semiconductor memory changes not only as a result of the number of rewrites, but also as a result of a frequency of rewriting. For example, deterioration of an FM chip, which is capable of 3000 rewrites, will advance when the rewrite frequency is increased, and at 1000 rewrites, the FM chip may lose its data retention capabilities and become less reliable as a storage medium.

Thus, in a NVM module 126, which uses memories having different rates of deterioration in accordance with the rewrite frequency, it is necessary to control the rewrite frequency so that service life is not shortened.

The NVM module 126 of the fourth example manages the rewrite frequency of the

FM chips (220 through 228), and when this rewrite frequency exceeds a rewrite frequency upper-limit threshold, increases a spare area (an area for saving a fixed amount of the invalid PBA capacity) to lower the rewrite frequency.

The reason for linking an increase in the spare area of the NVM module 126 to a lowering of the rewrite frequency will be explained below. The NVM module 126 of this example implements a data update to the same LBA in accordance with associating a different NVM module PBA with the same LBA, and storing the update data in the associated NVM module PBA.

Then, the NVM module 126 manages the NVM module PBA area storing the pre-update old data as an invalid PBA. In a case where the invalid PBA capacity exceeds a prescribed threshold, the NVM module 126 implements a reclamation for erasing the invalid PBA.

In the NVM module 126, which implements a reclamation process like this, the process having the highest rewrite frequency for a physical storage area is a localized data update to the NVM module 126.

For example, there are cases in which data continues to be updated only in a certain 16-KB area on the NVM module LBA. More specifically, in a case where a certain 16-KB area on the NVM module LBA has been rewritten 1024×1024=1048576 times in one hour, an area of 16 KB×1048576 times=approximately 16 GB has been rewritten in the NVM module PBA. In a case where the spare area is 1 GB at this time, each time 1 GB of invalid PBA capacity is saved, this 1 GB of invalid PBA capacity is erased in accordance with a reclamation, such that rewriting to the NVM module PBA area allocated to the spare area is implemented 16 GB/1 GB=16 times in one hour (rewriting at a frequency of once every 3.75 minutes).

Alternatively, in a case where the spare area is 2 GB, rewriting to the NVM module PBA area allocated to the spare area is implemented 16 GB/2 GB=8 times in one hour (rewriting at a frequency of once every 7.5 minutes). In a case where the amount of data updating to the NVM module LBA is identical like this, the rewrite frequency of the NVM module PBA, which is the physical area, will decrease the larger the spare area is (the rewrite interval is extended).

The reason for implementing control for increasing the spare area in order to lower the rewrite frequency has been explained hereinabove.

The configuration, management information, and processing of the storage apparatus 101 of the fourth example are substantially the same as the first example, and as such, explanations will be omitted. Furthermore, in the fourth example, control is performed using only the remaining PBA allocation capacity notified from the NVM module 126 without performing a calculation using the NVM module PBA allocation capacity 706 of the cache segment management information 700 as the method for acquiring the remaining PBA allocation capacity.

The configuration and the management information of the NVM module 126 of the fourth example are substantially the same as the first example, and as such, explanations will be omitted. The processing of the NVM module 126 of the fourth example will be explained by focusing on the points of difference with the first example.

The NVM module 126 of this example manages the time point of an erase performed with respect to a block comprising the FM chips (220 through 228) being managed for all blocks. When erasing a block, for example, the NVM module 126 calculates the erase frequency of each block in accordance with calculating the difference between the time point at the previous erase and the current time point.

Since this erase frequency is practically equivalent to the above-mentioned rewrite frequency in a nonvolatile semiconductor memory for which overwriting is not possible, this erase frequency for each block is regarded as the rewrite frequency of each block. Furthermore, the rewrite frequency is controlled by treating the minimum value of this rewrite frequency for each block as a representative value of each NVM module 126.

In this example, it is supposed that the rewrite frequency of each NVM module 126 is controlled by treating the minimum rewrite frequency value as a representative value, but the rewrite frequency may be controlled using an average rewrite frequency value.

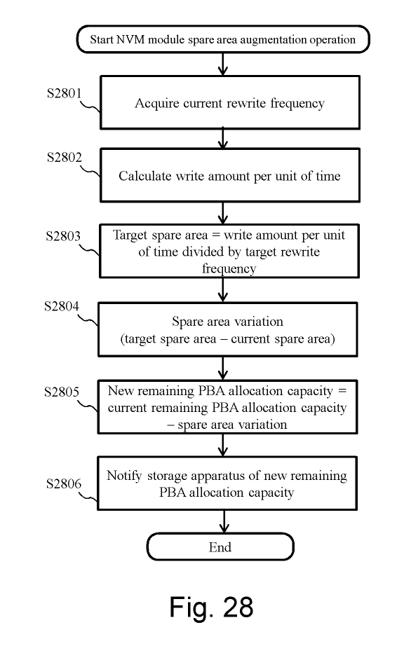

FIG. 28 shows an example of a spare area augmentation process performed by the NVM module 126 of the fourth example.

This process is implemented when the rewrite frequency exceeds a prescribed threshold. In S2801, the FM controller 210 acquires the current rewrite frequency for each block. The FM controller 210, for example, acquires a value, such as 4 times/hour.

In S2802, the FM controller 210 calculates a write amount per unit of time. Specifically, for example, the processor 215 calculates the product of the current rewrite frequency acquired in S2801 and the current spare area. In a case where the current rewrite frequency is 4 times/hour, the unit of time is one hour, and the spare area is 100 GB, the processor 215 calculates that (4 times/hour)×100 GB=400 GB.

In S2803, the FM controller 210 calculates a spare area, which will be an increase target. Specifically, for example, the processor 215 calculates the quotient obtained by dividing the write amount per unit of time calculated in S2802 by a target rewrite frequency. In a case where the write amount per unit of time is 400 GB, and the target rewrite frequency is 1 time/hour, the processor 215 calculates that 400 GB/(1 time/hour)=400 GB. In this example, since the rewrite frequency of 1 time/hour is realized by the current write amount, the processor 215 calculates 400 GB as the target spare area.

In S2804, the FM controller 210 calculates the difference between the target spare area calculated in S2803 by the NVM module 126 and the current spare area as the spare area variation.

In S2805, the FM controller 210 calculates the difference between the current remaining PBA allocation capacity 1102 of the NVM module 126 and the spare area variation calculated in S2804, and adds this difference to the current remaining PBA allocation capacity to obtain a new remaining PBA allocation capacity.

In S2806, the FM controller 210 notifies the storage controller 110 of the new remaining PBA allocation capacity calculated in S2805. According to this step, the storage controller 110 is able to judge whether or not the NVM module 126 remaining PBA allocation capacity has decreased, and can release clean-attribute segments until the remaining PBA allocation capacity becomes larger than a prescribed threshold. The NVM module 126 can increase the spare area in accordance with managing and controlling the NVM module PBA area released at this time as the spare area.

An example of the spare area augmentation process performed by the NVM module 126 of the fourth example has been explained hereinabove. Furthermore, a process for decreasing the spare area is realized by the NVM module 126 increasing the remaining PBA allocation capacity notified to the storage controller 110 and increasing the in-use segment capacity in the storage apparatus 101 when the rewrite frequency becomes equal to or less than a prescribed threshold.

As described hereinabove, in the fourth example, the NVM module 126 controls the remaining PBA allocation capacity notified to the storage apparatus 101 in order to calculate the ideal capacity of the spare area in accordance with the rewrite frequency to realize this spare area.

In a case where the remaining PBA allocation capacity notified from the NVM module 126 has decreased, the storage controller 110 causes the NVM module 126 to decrease the number of segments in use in accordance with the segment release processing of S1401 through S1407 described in the first example. In a case where the remaining PBA allocation capacity has increased, the storage controller 110 causes the NVM module 126 to increase the number of segments in use in accordance with the various controls described in the first example.

In this example, the capacity of the NVM module LBA, which the NVM module 126 provides to the storage controller 110, is virtualized, and the storage controller 110 comprises a function for changing the number of segments in use described in the first example. Thus, the NVM module 126 is able to change the NVM module LBA capacity that it allows the storage controller 110 to use in accordance with increasing and decreasing the rewrite frequency of a block.

The NVM module 126 is also able to freely control the capacity of the spare area in accordance with the rewrite frequency. That is, when the rewrite frequency is high, the NVM module 126 can control the physical storage area rewrite frequency to exhibit equal to or less than a fixed value in accordance with increasing the capacity of the spare area, making it possible to maintain the reliability related to the data retention capability of the NVM module 126. Alternatively, when the rewrite frequency is low, the NVM module 126 can reduce the capacity of the spare area, and control the NVM module LBA capacity that the storage controller 110 is able to use to equal to or larger than a fixed value, making it possible to increase the cache capacity that the storage controller 110 is able to use.

The numerous examples describe above are illustrations for explaining the present invention, and do not purport to limit the scope of the present invention only to these examples. A person with ordinary skill in the art will be able to put the present invention into practice using a variety of other modes without departing from the gist of the present invention.

### REFERENCE SIGNS LIST

101 Storage apparatus

110 Storage controller

126 NVM module

210 Flash memory controller

1. A storage apparatus, comprising:
a controller for performing, with respect to a storage device, which is the basis of an access-destination storage area, an access of access-target data, which conforms to an access command from a higher-level apparatus; and
a cache memory (CM) in which access-target data to be accessed with respect to the storage device is temporarily stored,
wherein the CM comprises a nonvolatile semiconductor memory (NVM) as a storage medium,
the CM provides the controller with a logical space, and the controller manages the logical space by partitioning this space into multiple segments and accesses the CM by specifying a logical address of the logical space, and the CM receives the logical address-specified access and accesses, from among multiple physical areas comprising the NVM, a physical area allocated to a logical area, which belongs to the controller-specified logical address,
a first management unit, which is a unit of a segment, is larger than a second management unit, which is a unit of an access performed with respect to the NVM in the CM, and
the capacity of the logical space is a larger capacity than the storage capacity of the NVM.

2. A storage apparatus according to claim 1, wherein the controller manages an attribute of each of multiple segments, which comprise the logical space,
as a segment attribute, there is dirty, which signifies a segment in which is stored data that is not stored in the storage device, clean, which signifies a segment in which is stored data that is stored in the storage device, and free, which signifies a segment to which new data may be written,
the remaining capacity of the logical space is the total capacity of a free segment,
the controller is configured to receive from the CM internal information comprising capacity information related to a remaining capacity, which is the total capacity of a free physical area in the NVM,
a free physical area is a storage area, which is not allocated to any logical area and to which data can be written anew, and
the controller, in accordance with a prescribed trigger, identifies the remaining capacity of the CM based on the capacity information, and in a case where the identified remaining capacity is equal to or less than a prescribed threshold, changes the attribute of a clean segment to free so that the remaining capacity becomes larger than the prescribed threshold.

3. A storage apparatus according to claim 2, wherein the controller notifies the CM of the logical address of the segment for which the attribute is to be changed to free, and the CM changes a physical area to a free physical area with respect to the logical area belonging to the notified logical address.

4. A storage apparatus according to claim 3, wherein the CM is configured to send the internal information to the controller in a case where a write request in which a logical address is specified is received from the controller, and, in addition, data conforming to the write request is written in a physical area, which has been allocated to the logical area belonging to the logical address specified in the write request, and
the prescribed trigger is the time at which the controller received the internal information from the CM in response to the write request.

5. A storage apparatus according to claim 4, wherein a write request from the controller to the CM is either a write request for data, which is data conforming to a read command received as the access command, and is read from the storage device, or a write request for data, which conforms to a write command received as an access command from the higher-level apparatus.

6. A storage apparatus according to claim 2, wherein the capacity information is pseudo capacity information via which a remaining capacity, which is smaller than the actual remaining capacity of the NVM, is identified.

7. A storage apparatus according to claim 6, wherein the capacity information is regarded as the pseudo capacity information in a case where the NVM rewrite frequency is larger than a prescribed threshold.

8. A storage apparatus according to claim 3, wherein, as an attribute of the segment, there is free wait, which signifies an allowed segment, from among the clean segments, which stores data that has been accessed relatively fewer times,
the controller notifies the CM of multiple free wait addresses, and the CM selects a physical area serving as a free physical area from among multiple physical areas respectively allocated to multiple logical areas belonging to the multiple free wait addresses, and the free wait address is a logical address, which belongs to a free wait segment.

9. A storage apparatus according to claim 8, wherein the NVM is a flash memory comprising multiple physical blocks each configured from multiple physical pages,
the CM, in a reclamation process for increasing free physical blocks, selects a physical block to serve as a free physical block from among multiple physical blocks allocated to multiple logical blocks belonging to multiple free wait addresses so that the total amount of valid data to be migrated becomes equal to or less than a prescribed threshold.

10. A storage apparatus according to claim 8, wherein the CM, in a case where an access specifying a free wait address, which corresponds to the selected physical block, has been received from the controller, notifies the controller of the fact that the specified free wait address has been rendered free.

11. A storage apparatus according to claim 8, wherein the CM notifies the controller of a free wait address, which correspond to the selected physical block, and renders as a free physical area only the physical area corresponding to the free wait address, which has been approved by the controller from among the notified free wait addresses.

12. A storage apparatus according to claim 2, wherein the CM, in a case where data from the controller is compressed and stored in the NVM, and, in addition, the compressed data has been stored, is configured so as to update capacity information in accordance with the capacity of the physical area in which the compressed data has been stored, and to send the internal information, which comprises the post-update capacity information, to the storage controller.

13. A storage apparatus according to claim 1, wherein the logical space capacity is a capacity, which has been decided based on the ratio of the first management unit to the second management unit and the storage capacity of the NVM.

14. A storage control method comprising:
providing a logical space to a controller, which receives an access command from a higher-level apparatus and, in accordance with the access command, performs an access of access-target data with regard to a storage device, which is the basis of an access-destination storage area, in accordance with a cache memory (CM), which comprises a nonvolatile semiconductor memory (NVM) and temporarily stores access-target data accessed with respect to the storage device; and
in accordance with the CM, receiving from the controller an access, which specifies a logical address of the logical space comprising multiple segments, and accessing a physical area, which is allocated to a logical area belonging to a logical address specified by the controller, from among multiple physical areas comprising the NVM,
wherein a first management unit, which is a unit of a segment, is larger than a second management unit, which is a unit of an access performed with respect to the NVM in the CM, and
the capacity of the logical area is a larger capacity than the storage capacity of the NVM.

15. A storage control method according to claim 14, wherein the controller is constituted to manage an attribute of each of multiple segments, which comprise the logical space,
as a segment attribute, there is dirty, which signifies a segment in which is stored data that is not stored in the storage device, clean, which signifies a segment in which is stored data that is stored in the storage device, and free, which signifies a segment to which new data may be written,
the remaining capacity of the logical space is the total capacity of a free segment,
the CM sends the controller internal information comprising capacity information related to a remaining capacity, which is the total capacity of a free physical area in the NVM,
a free physical area is a storage area, which is not allocated to any logical area and to which data can be written anew, and the controller is configured so as to identify, in accordance with a prescribed trigger, the remaining capacity of the CM based on the capacity information, and in a case where the identified remaining capacity is equal to or less than a prescribed threshold, to change the attribute of a clean segment to free so that the remaining capacity becomes larger than the prescribed threshold.
